(19) United States
(12) Patent Application Publication
(10) Pub. No.: US 2026/0302905 A1
(43) Pub. Date: Oct. 1, 2026

(54) METHOD AND SYSTEM OF WELDING FOR INDUCTIVE WINDINGS OF ELECTRICAL MACHINES

(71) Applicant: ATOP S.P.A., Barberino Tavarnelle (IT)

(72) Inventors: Rubino CORBINELLI, Poggibonsi, Frazione Staggia Senese (IT); Daniele NOCCIOLINI, Firenze (IT); Davide CHESI, Certaldo (IT); Barbara PREVITALI, Milano (IT); Ali Goekhan DEMIR, Milano (IT); Leonardo CAPRIO, Milano (IT); Simone D'ARCANGELO, Pescara (IT)

(21) Appl. No.: 19/479,424

(22) PCT Filed: May 22, 2024
(86) PCT No.: PCT/IB2024/054980

§ 371 Date: Oct. 28, 2025

(30) Foreign Application Priority Data
May 22, 2023 (IT) 102023000010290

(51) Int. Cl. H02K 15/35; B23K 26/03; B23K 26/082; B23K 26/21; B23K 31/12; B23K 37/04; G01N 21/71

(52) U.S. Cl. CPC H02K 15/35; B23K 26/032; B23K 26/082; B23K 26/21; B23K 31/125; B23K 37/0435; G01N 21/718

(57) ABSTRACT

A method of welding for inductive windings of electrical machines starting from U-shaped conducting elements with a bridge joining a pair of shanks, wherein the conducting elements are arranged in a ferromagnetic core of an electrical machine with the shanks oriented parallel to an axis of symmetry of the ferromagnetic core, and wherein each shank of the conducting elements comprises an end, each end being adjacent to an end of another conducting element for welding together according to a predefined electrical connection diagram.

The present invention relates to a method and a system of welding for inductive windings of electrical machines, where this welding produces a weld joint between a pair of ends (or terminals) of conducting elements, in particular conducting elements of the hairpin type-briefly: hairpin conducting elements, and more briefly simply hairpins, of an inductive winding of a stator.

The method and the system according to the present invention are particularly, although not exclusively, useful and practical in the area of quality control of welding operations of the conducting elements that constitute the inductive windings of stators of electrical machines, for example electric motors or electricity generators.

It is known that electric motors, dynamos, alternators and transformers comprise a core of ferromagnetic material on which windings are arranged which are made with electrical wires arranged according to a specific geometry. The circulation of an electric current in at least one of the windings determines, by electromagnetic induction, the circulation of an induced current in at least one other winding. Furthermore, between the ferromagnetic core and the respective windings, forces act on each other and are capable, for example, of turning a rotor with respect to a stator in an electric motor.

As said, the above-described inductive windings are made using wires of electrically conducting material, generally copper. For specific applications, inductive windings are made using wire-like elements of electrically conductive material-briefly: conducting elements-which are coated by an insulating material, generally polymer.

First, an end portion of the conducting elements is deinsulated, by removal of the insulating material, and then these conducting elements are suitably shaped and inserted into specific slots which provided in the ferromagnetic core of the electrical machine under construction, and finally these conducting elements are mutually stably coupled at at least one end, typically by means of welding operations.

The quality of the welded joint depends on the quality of the processes of deinsulating and shaping of the conducting elements, since these processes determine the coupling tolerances.

A typical example of these conducting elements is the “hairpin”, where each conducting element is shaped like a fork. This fork has a pair of straight shanks which are mutually connected at one end by a bridge-like cross-part. Typically the fork is shaped approximately like an upturned U with the bridge shaped like a cusp. Each shank of the fork, and thus of the conducting element, has a free end for insertion in a respective slot of the ferromagnetic core of the electrical machine. In particular, a first end of each conducting element is inserted into a respective first slot, while a second end of the same conducting element is inserted into a respective second slot, according to the desired logic for the inductive winding of the electrical machine.

The insertion into the slots of the ferromagnetic core of the electrical machine occurs by inserting the free ends of the conducting elements through longitudinal openings of the slots and by making said free ends slide until they come out at the other end of the ferromagnetic core, in particular until a predefined external protrusion of the shanks is reached. Hence, at one end of the ferromagnetic core, the bridges of the forks remain outside, while at the other end of the ferromagnetic core the free ends of the shanks of the forks remain outside.

After insertion, the free ends of the conducting elements are bent in order to be arranged in predetermined positions, at which predetermined positions the free ends of the conducting elements are connected with other free ends of other conducting elements through welding operations. The free ends of separate conducting elements must be adjacent and arranged according to criteria for mutual alignment that make the welding operations simple and which ensure a high stability of the connection. For example, in a pair of adjacent free ends that are to be mutually connected, the first end can have a height (i.e. external protrusion) that is slightly higher than the height (i.e. external protrusion) of the second end, thereby enabling the welding operation to make a gob of molten material of the first end fall onto the second end.

The welding operation to bond the free ends of the conducting elements can occur by way of various welding techniques, but typically it occurs using a laser welding beam that strikes one or both of the free ends of the conducting elements which are arranged adjacent in order to be mutually connected. Commonly, when laser-welding the free ends of conducting elements, the process uses a laser beam of the near-infrared (NIR) type with a wavelength typically comprised between 1,000 and 1,080 nm.

Independently of the welding technique used, the melting of the material of one or both of the ends generates a weld joint that complies with the required mechanical and electrical characteristics, and thus closes the circuit of the inductive winding according to a predefined electrical diagram.

The quality of the welding operations—and, consequently, the quality of the weld joints between the ends of the conducting elements or hairpins of an inductive winding of a stator—can be assessed on the basis of various elements, including: the volume of the weld joint; the quality of the deinsulation of the conducting elements; possible explosion of the joint during the welding operation; the internal porosity of the weld joint; and the mechanical strength (pull-out force) of the weld joint.

Currently, human operators—typically, laboratory technicians—are used to judge the quality (also from the aesthetic point of view) of the weld joints (or “welds”) between the ends of the conducting elements or hairpins of an inductive winding of a stator. In particular, these operators examine these welds visually, basing their judgment mainly on their own professional experience and using appropriate magnifying devices (for example a digital microscope) and/or measurement devices. The objective of these quality controls performed by human operators is to verify that the welds between the ends of the conducting elements ensure a stable and strong coupling of said ends and that the welds have no aesthetic defects. The operators will discard stators with defective inductive windings, or rather inductive windings that comprise conducting elements at whose ends there are defective welds.

However, this known methodology is not without drawbacks, including the fact that these quality controls performed by human operators require long times, generate high costs and imply a high risk of inaccuracies and human error in the examination and evaluation of the welds.

Another drawback of this known methodology consists in that, in welds, some burring is often present which further complicates the work of the operators, making the assessment of the quality of the welds substantially subjective. In other words, the laboratory measurements of the welds are conditioned by human operators.

A further drawback of this conventional methodology consists in that the laboratory measurements of the welds are often performed from a single point of view. This is necessary owing to the shape structure of the stator and of the associated inductive winding: the welds are positioned very close to each other and thus the hindrance of the adjacent welds does not allow to analyze the welds inside the “corona” (i.e. the area surrounding the nugget of a spot weld) from other points of view. Obviously, a laboratory technician could cut one or more welds and analyze them from various points of view. However, this operation would require a great deal of time and, due to the cutting of the weld joints, entail a risk of degrading the actual measurements.

The aim of the present invention is to overcome the limitations of the known art described above, by devising a method and a system of welding for inductive windings of electrical machines that make it possible to obtain better effects than those that can be obtained with conventional solutions and/or similar effects at lower cost and with higher performance levels.

Within this aim, an object of the present invention is to conceive a method and a system of welding for inductive windings of electrical machines that make it possible to examine and evaluate the welds objectively and rapidly.

Another object of the present invention is to devise a method and a system of welding for inductive windings of electrical machines that make it possible to immediately discard a stator that has an inductive winding comprising a pair of conducting elements with an exploded weld, so saving the automatic welding process from executing all the subsequent welding operations and, thus, all the subsequent welds, thereby basically reducing the cycle times for discarded stators.

Another object of the present invention is to conceive a method and a system of welding for inductive windings of electrical machines that make it possible to immediately rework a poor quality weld in the welding machine, so avoiding the need to extract the stator from the welding machine and then put it back into the same machine later, after visual inspection of that stator by a human operator, thereby basically reducing the cycle times for reworking.

Another object of the present invention is to devise a method and a system of welding for inductive windings of electrical machines that makes it possible to correctly classify various types of defects, identifying one or more of the following defects: poor or insufficient weld volume, owing to lack of power and/or loss of focal position of the laser welding beam; poor or insufficient quality of deinsulation of the conducting elements; explosion of the weld; poor or insufficient internal porosity of the weld; and poor or insufficient mechanical strength (pull-out force) of the weld.

Another object of the present invention is to provide a method and a system of welding for inductive windings of electrical machines that are highly reliable, easy to carry out, and economically competitive when compared to the known art.

This aim and these and other objects which will become better apparent hereinafter are achieved by a method of welding for inductive windings of electrical machines according to claim 1.

The aim and objects are also achieved by a system of welding for inductive windings of electrical machines according to claim 7.

Further characteristics and advantages of the present invention will become better apparent from the detailed description of a preferred, but not exclusive, embodiment of the method and of the system of welding for inductive windings of electrical machines according to the invention, illustrated by way of non-limiting example with the aid of the accompanying drawings wherein:

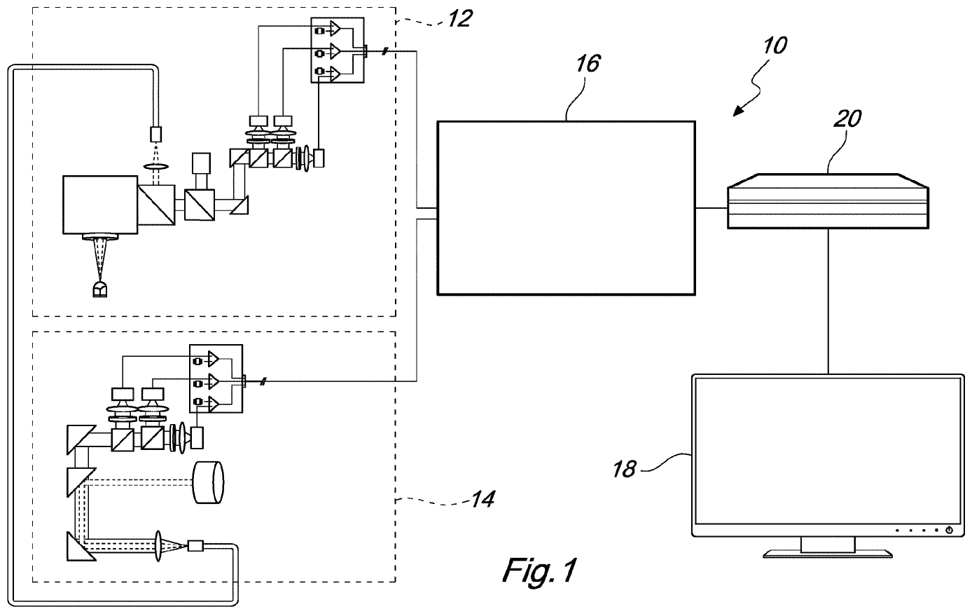

FIG. 1 is a schematic block diagram of an embodiment of the system of welding for inductive windings of electrical machines according to the present invention;

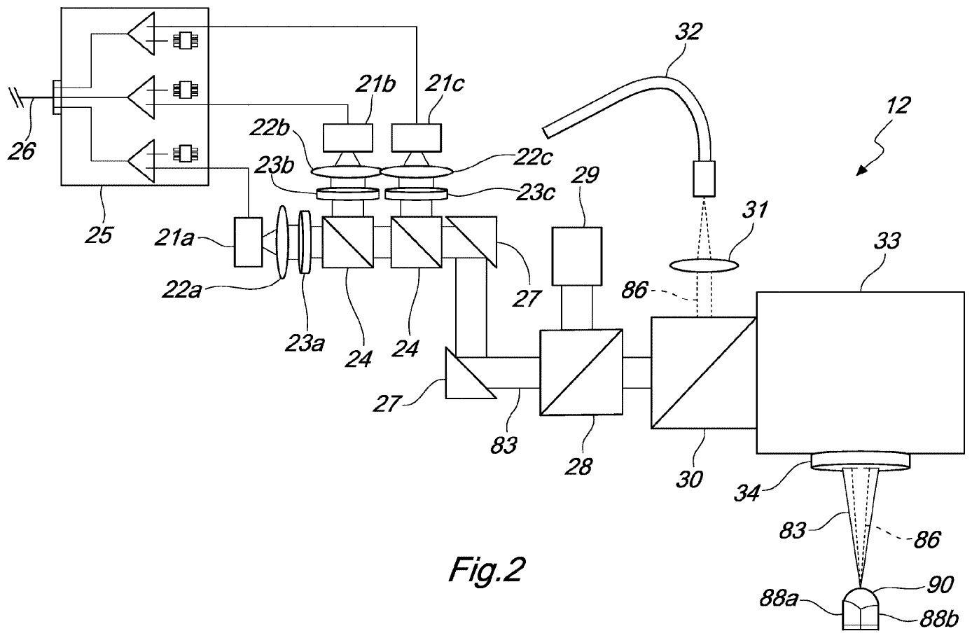

FIG. 2 is a schematic block diagram of a first embodiment of the optical sensor device of the system of welding for inductive windings of electrical machines according to the present invention;

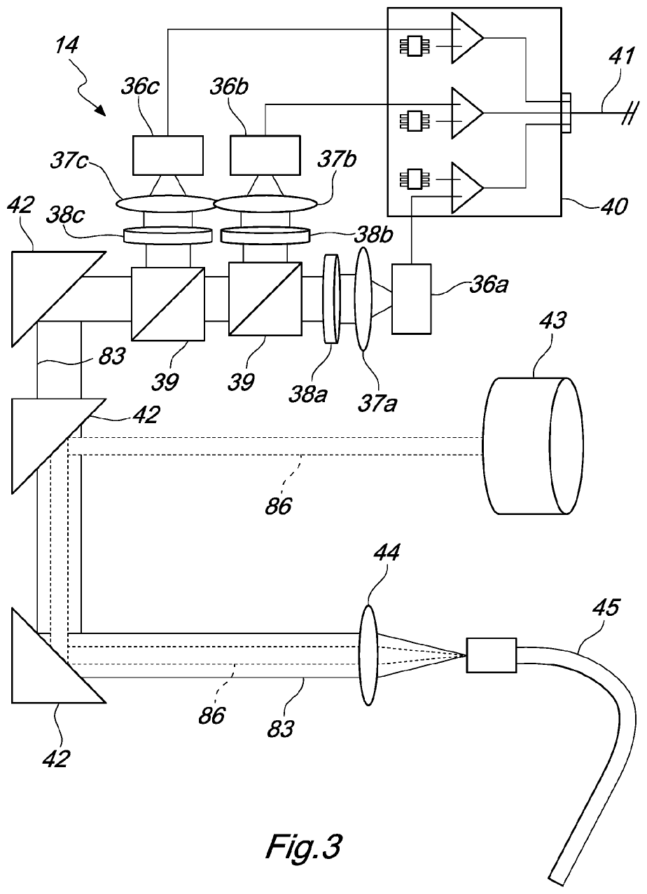

FIG. 3 is a schematic block diagram of a second embodiment of the optical sensor device of the system of welding for inductive windings of electrical machines according to the present invention;

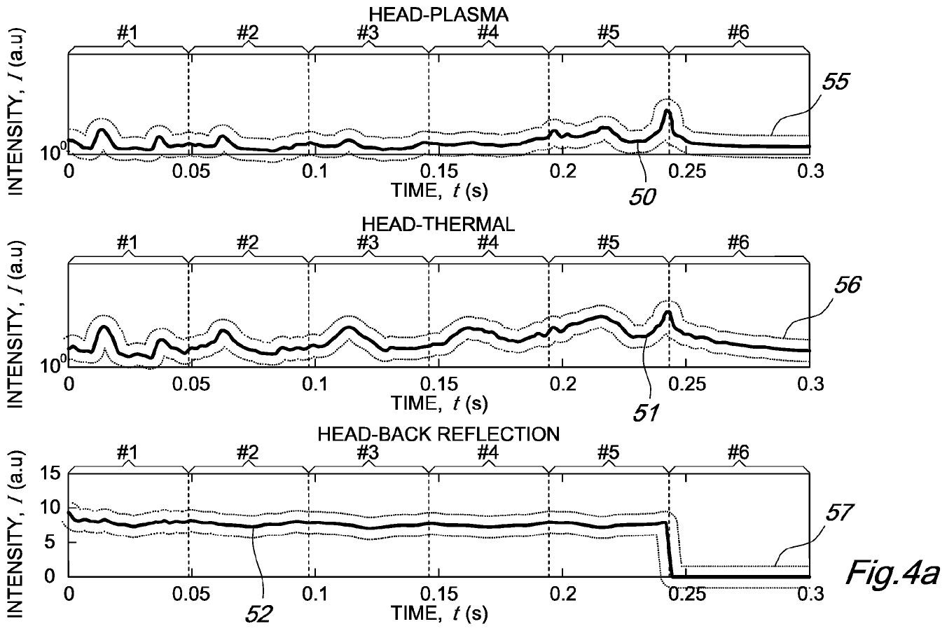

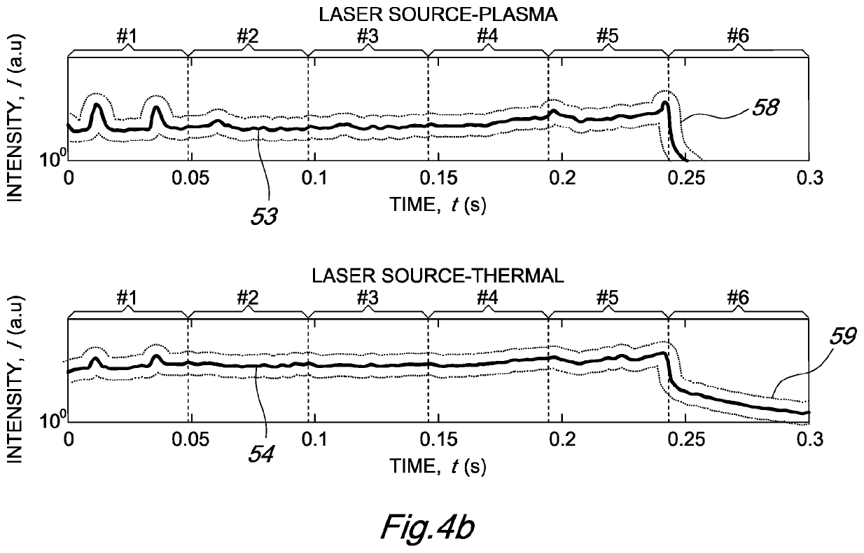

FIGS. 4a and 4b are a first set of graphs, each showing an example of the trend of a respective reference signal and of a respective tolerance band, within the framework of the method and the system of welding for inductive windings of electrical machines according to the present invention;

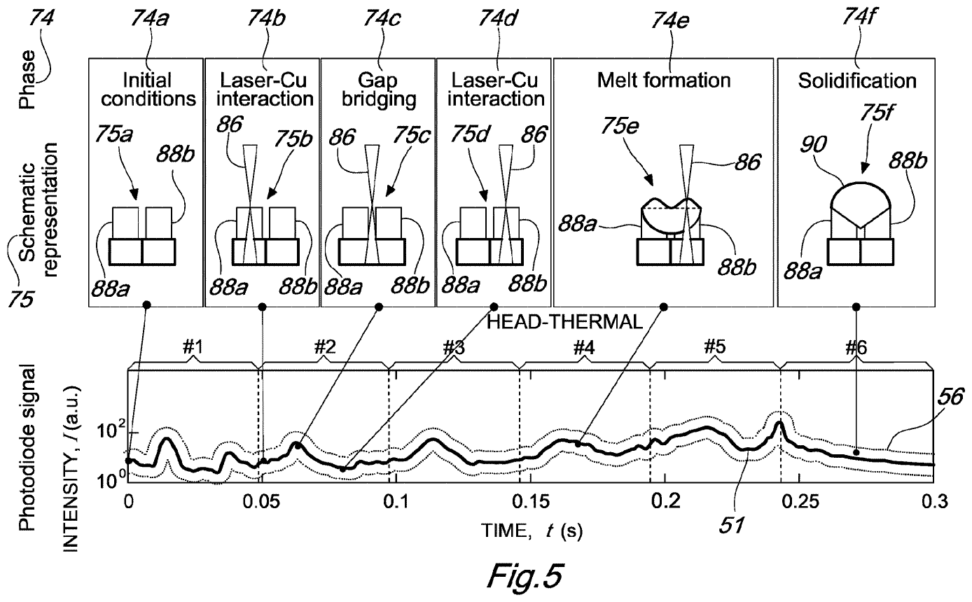

FIG. 5 is a schematic view of an example of correlation between the various phases of the welding operation of a pair of ends of conducting elements and the respective portions of a real or reference signal, —in this example: the reference thermal signal—of the optical emission of the weld, each phase being accompanied by a respective schematic representation;

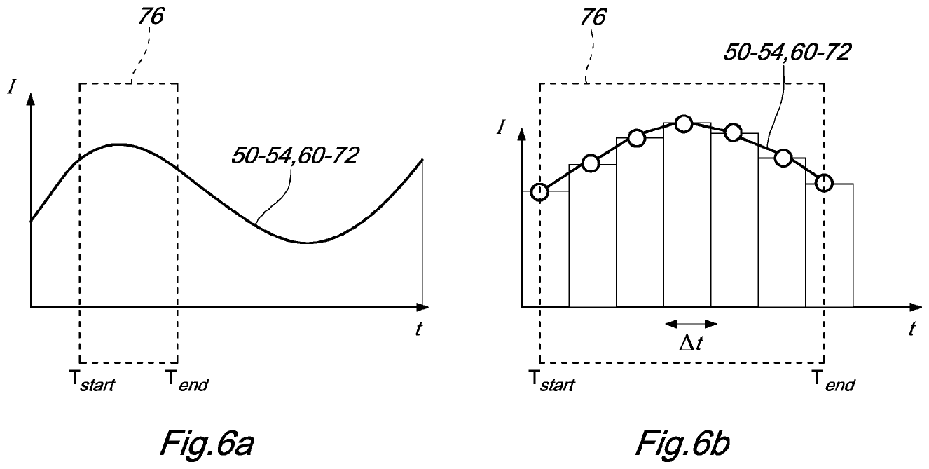

FIGS. 6a and 6b are schematic views of respective time windows from which to extract the physical indicators of a real or reference signal of the optical emission of the weld, by using respectively a first extraction method and a second extraction method, within the framework of the method and the system of welding for inductive windings of electrical machines according to the present invention;

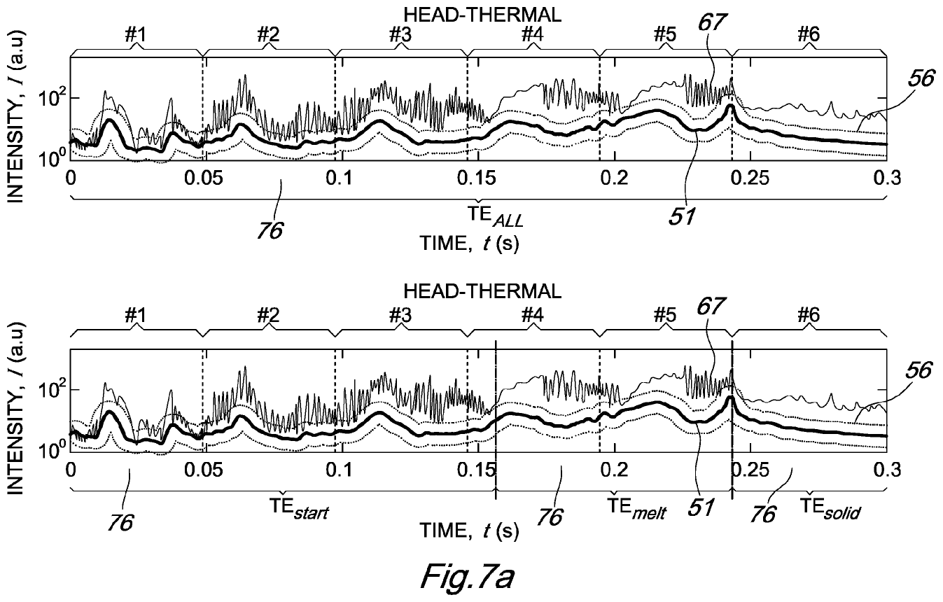

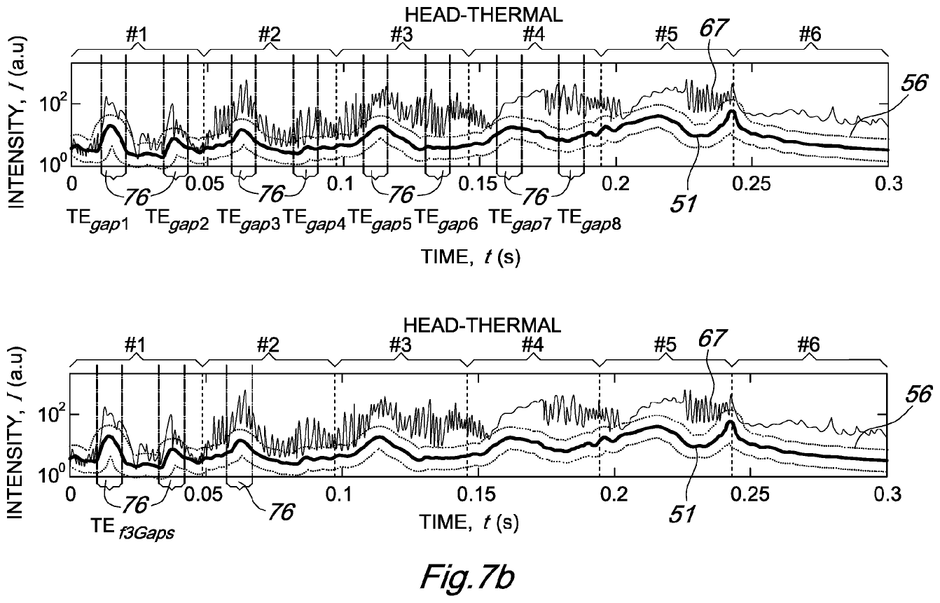

FIGS. 7a and 7b are a second set of graphs, each showing one or more time windows from which to extract the physical indicators of a thermal (or plasma) real or reference signal of the optical emission of the weld, within the framework of the method and the system of welding for inductive windings of electrical machines according to the present invention;

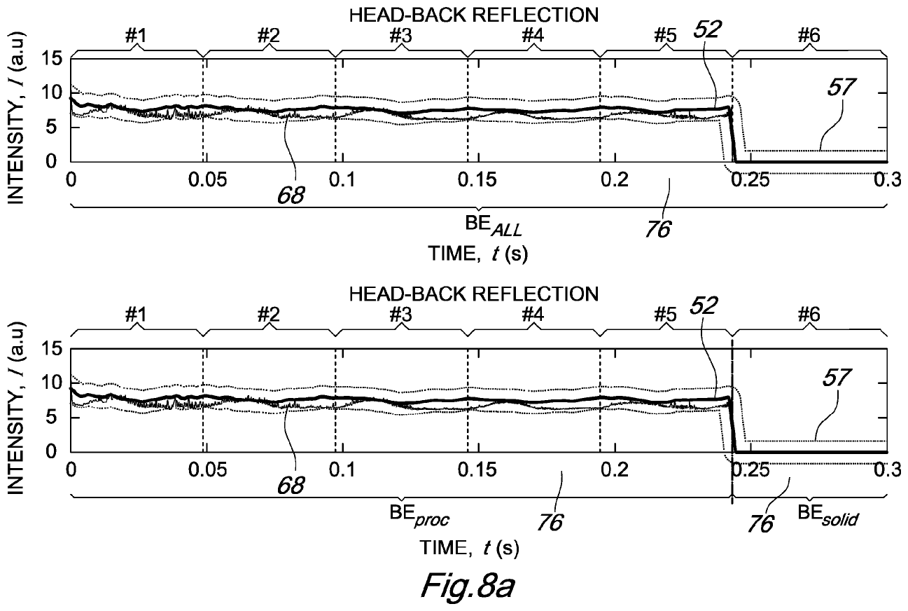

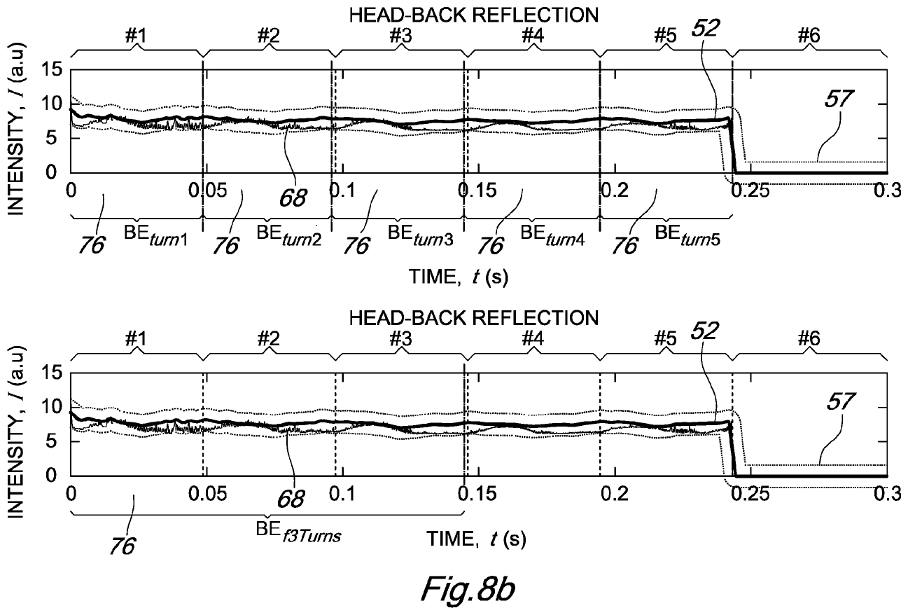

FIGS. 8a and 8b are a third set of graphs, each showing one or more time windows from which to extract the physical indicators of a back-reflection—real or reference—signal of the optical emission of the weld, within the framework of the method and the system of welding for inductive windings of electrical machines according to the present invention;

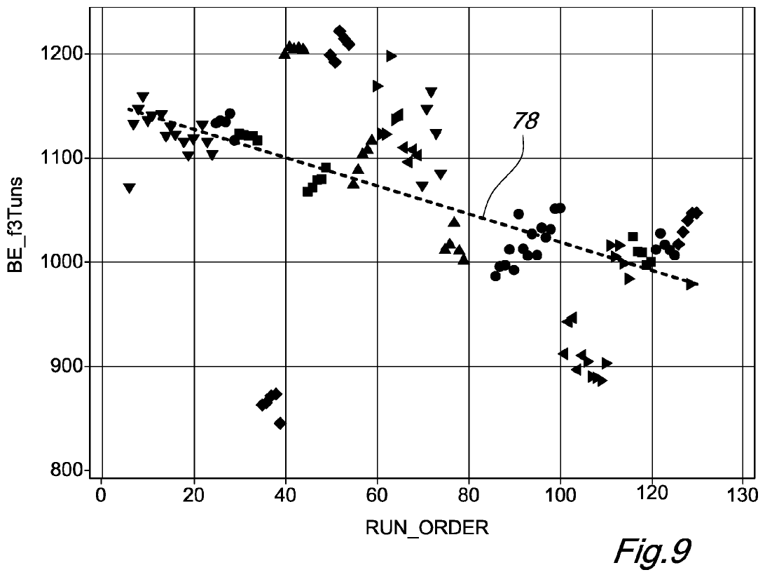

FIG. 9 is a graph showing an example of direct use of a physical indicator extracted from a signal—in this example: the real back-reflection signal—of the optical emission of the weld, in order to identify a defect in the weld, within the framework of the method and the system of welding for inductive windings of electrical machines according to the present invention;

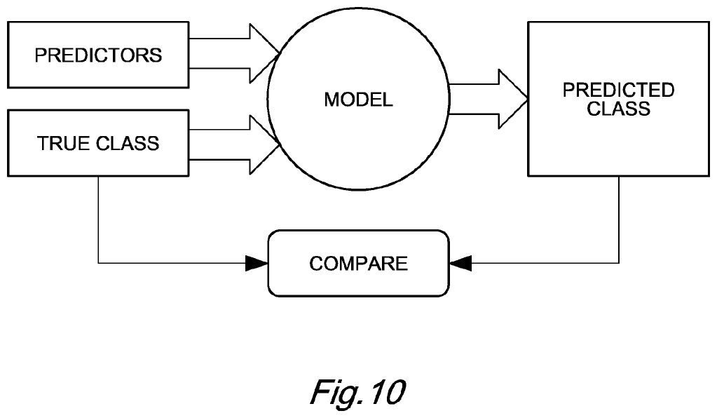

FIG. 10 is a schematic block diagram of a supervised machine learning approach in which it is possible to use physical indicators extracted from real or reference signals;

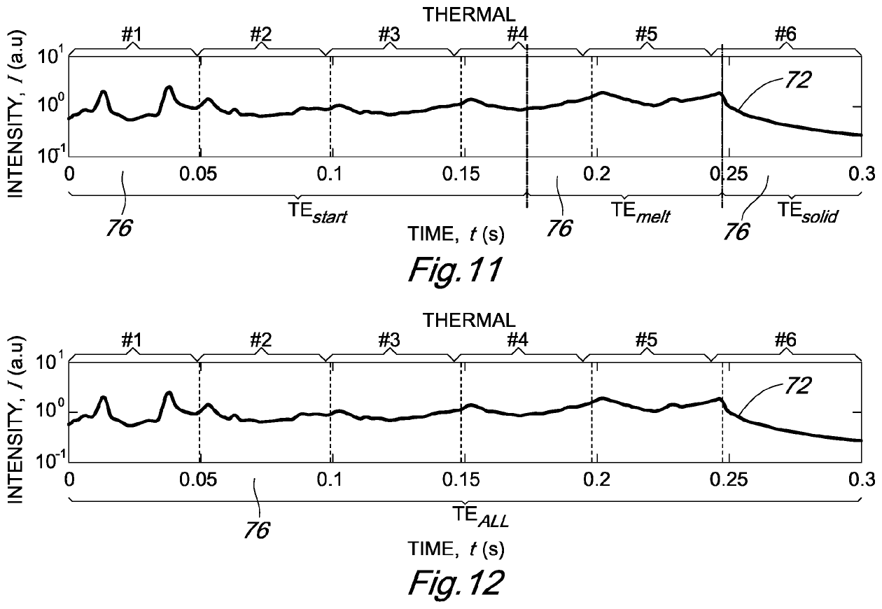

FIG. 11 is a graph showing an example of the trend of a real thermal signal obtained from the optical emission of the weld, the defect in this case being poor or insufficient internal porosity of the weld, within the framework of the method and the system of welding for inductive windings of electrical machines according to the present invention;

FIG. 12 is a graph showing an example of the trend of a real thermal signal obtained from the optical emission of the weld, the defect in this case being poor or insufficient mechanical strength (pull-out force) of the weld, within the framework of the method and the system of welding for inductive windings of electrical machines according to the present invention;

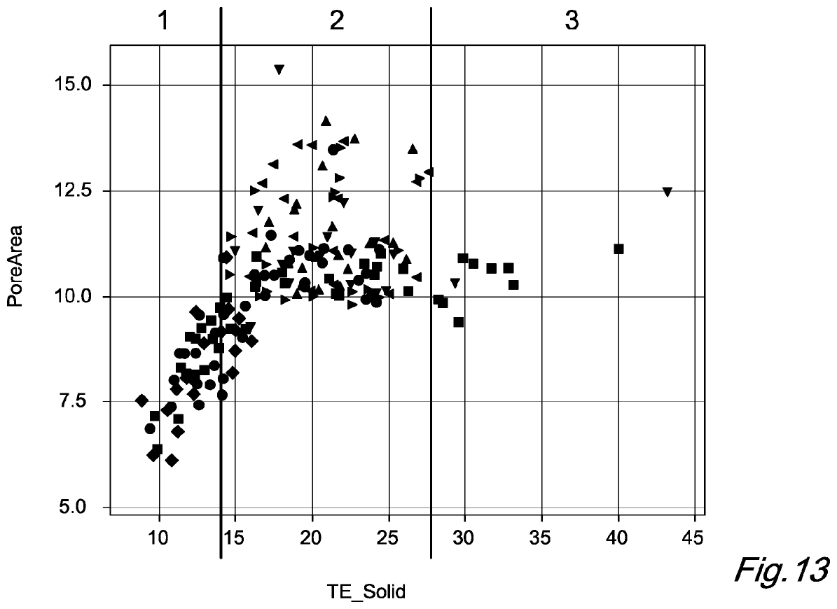

FIG. 13 is a graph showing an example of the distribution of a physical indicator—in this example: TE_Solid—of a real thermal signal obtained from the optical emission of the weld, the defect in this case being poor or insufficient internal porosity of the weld, within the framework of the method and the system of welding for inductive windings of electrical machines according to the present invention;

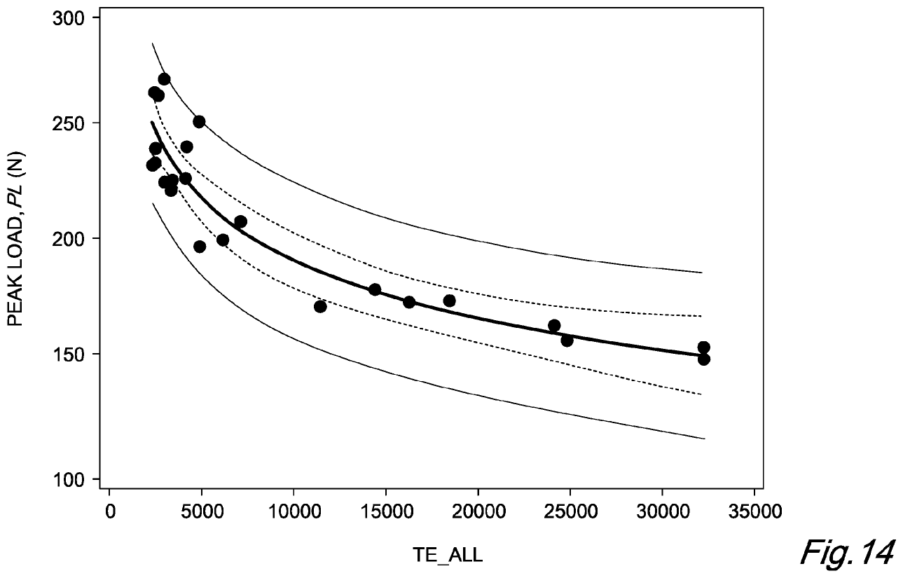

FIG. 14 is a graph showing an example of the distribution of a physical indicator—in this example: TE_All—of a real thermal signal obtained from the optical emission of the weld, the defect in this case being poor or insufficient mechanical strength (pull-out force) of the weld, within the framework of the method and the system of welding for inductive windings of electrical machines according to the present invention;

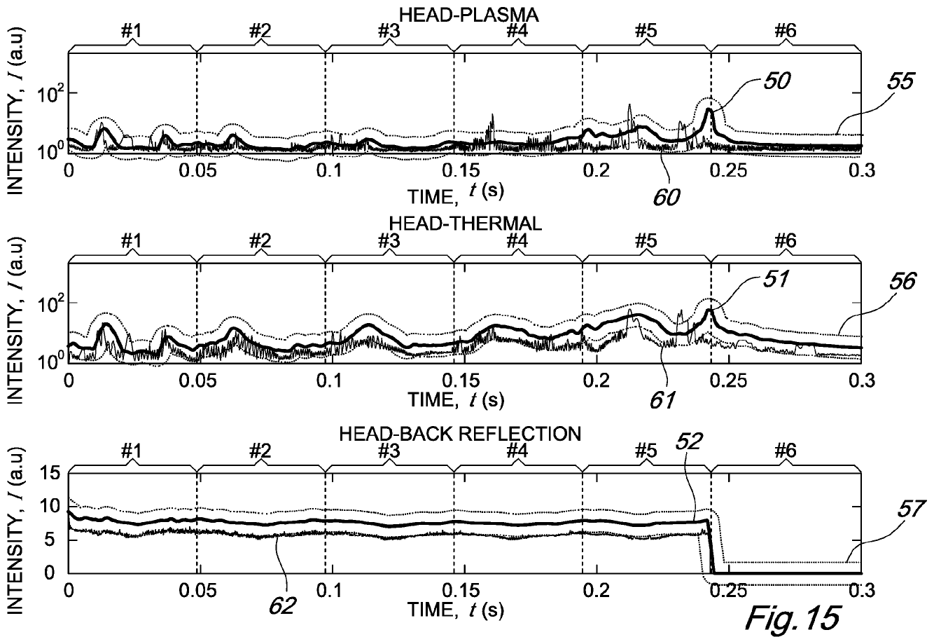

FIG. 15 is a fourth set of graphs, each showing an example of the superimposed trends of a respective reference signal and of a respective real signal, the latter signal being obtained from the optical emission of the weld, the defect in this case being poor or insufficient weld volume owing to lack of power of the laser welding beam, within the framework of the method and the system of welding for inductive windings of electrical machines according to the present invention;

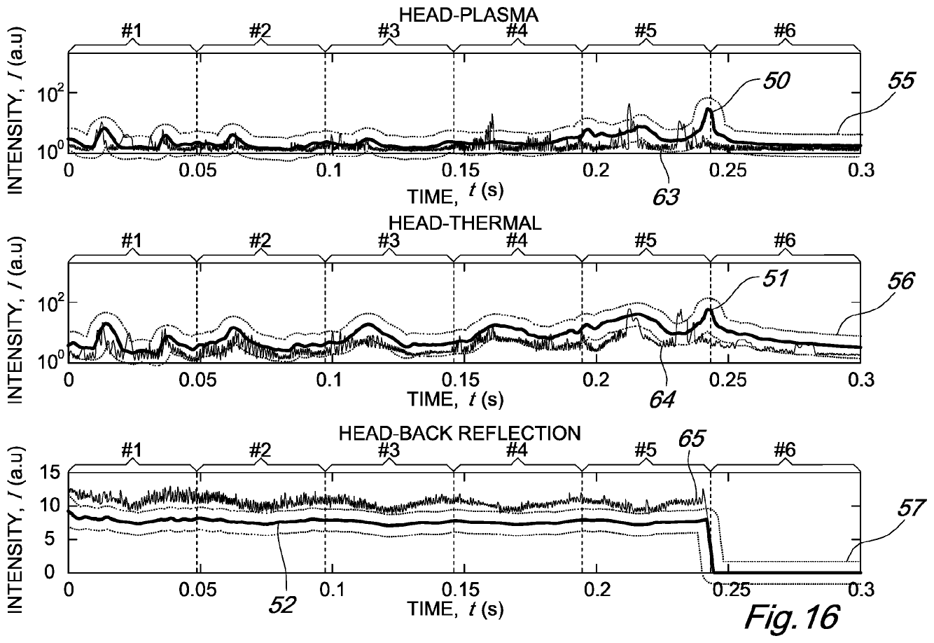

FIG. 16 is a fifth set of graphs, each showing an example of the superimposed trends of a respective reference signal and of a respective real signal, the latter signal being obtained from the optical emission of the weld, the defect in this case being poor or insufficient weld volume owing to loss of focal position of the laser welding beam, within the framework of the method and the system of welding for inductive windings of electrical machines according to the present invention;

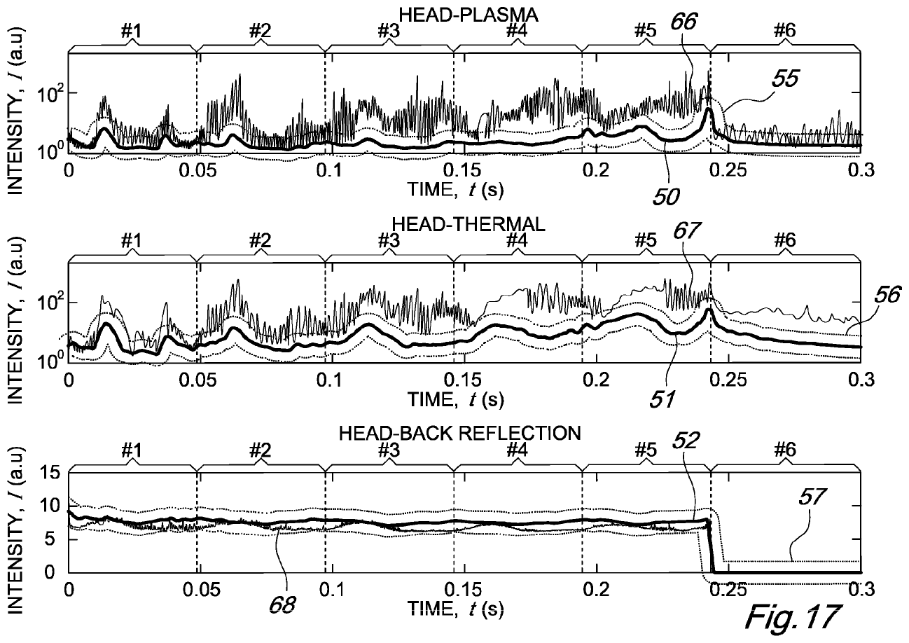

FIG. 17 is a sixth set of graphs, each showing an example of the superimposed trends of a respective reference signal and of a respective real signal, the latter signal being obtained from the optical emission of the weld, the defect in this case being poor or insufficient quality of deinsulation of the conducting elements, within the framework of the method and the system of welding for inductive windings of electrical machines according to the present invention;

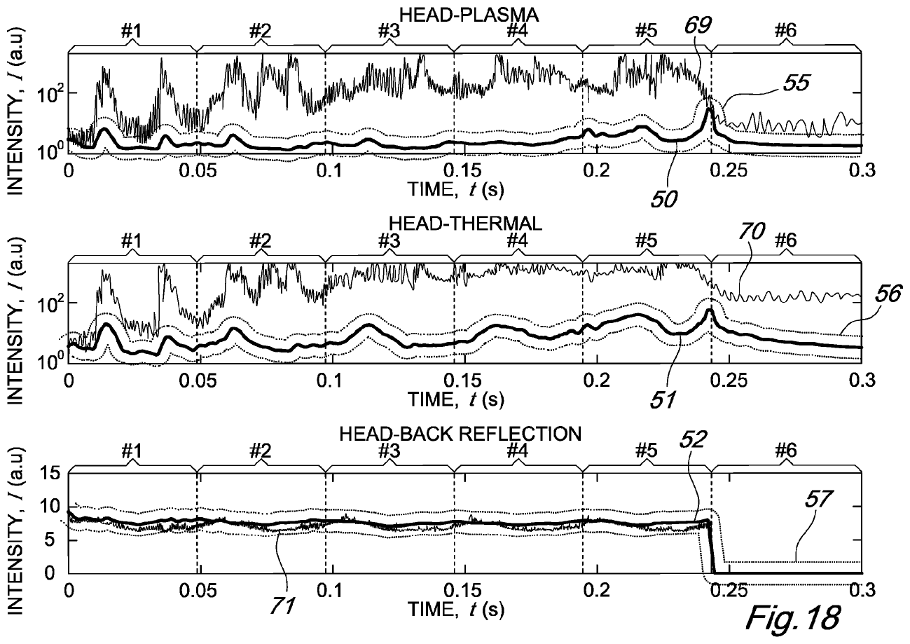

FIG. 18 is a seventh set of graphs, each showing an example of the superimposed trends of a respective reference signal and of a respective real signal, the latter signal being obtained from the optical emission of the weld, the defect in this case being an explosion of the weld, within the framework of the method and the system of welding for inductive windings of electrical machines according to the present invention;

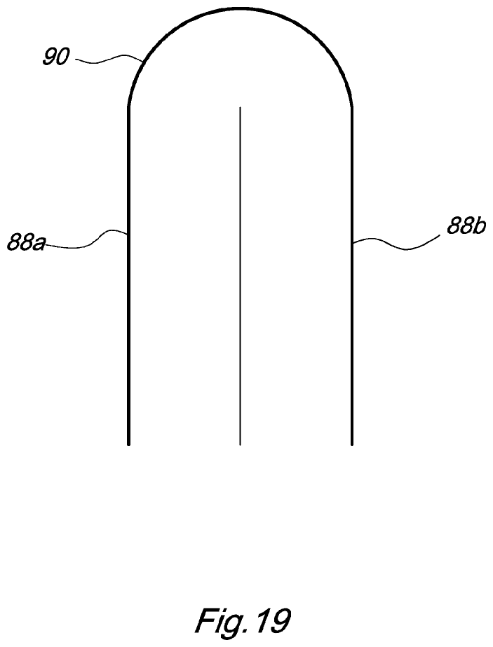

FIG. 19 is a schematic elevation view of a weld joint between a pair of ends of conducting elements of an inductive winding of a stator.

It is to be noted that, in the graphs in FIGS. 4a, 4b, 5, 7a to 8b, 11, 12 and 15 to 18, the time—represented on the axes of the abscissas—is divided into a plurality of time periods, indicated respectively with the reference numerals #1, #2, #3, #4, #5 and #6. Each time period #1-#6 is defined by an initial moment in time and a final moment in time, indicated respectively by the left-hand end and by the right-hand end of the curly brackets indicating those time periods #1-#6.

Each time period #1-#6 relates to a respective phase of the welding operation of the pair of ends of the conducting elements. In particular, each time period #1 to #5 relates to a respective rotation or scan (where these two terms are to be understood as synonyms) of the laser welding beam 86 during the welding operation.

Time periods #1 and #2 relate to the initial phase of the welding operation. The time period #3 relates to the transition phase of the welding operation, corresponding to the start of the formation of the melt and, therefore, of the weld 90. Time periods #4 and #5 relate to the final phase of the welding operation, corresponding to the end of the formation of the melt and, therefore, of the weld 90. Finally, the period #6 relates to the concluding phase of the welding operation, corresponding to the cooling and solidification of the melt and, therefore, of the weld 90.

Consequently, in the graphs in these figures, the reference signals and/or the real signals, shown on the axes of the ordinates, can be subdivided into a plurality of sections, each one comprised in a respective time period and therefore relating to a respective phase of the welding operation of the pair of ends 88a, 88b of the conducting elements.

Advantageously, the system 10 of welding for inductive windings of electrical machines according to the present invention is configured to execute the welding operation and control the quality of the weld 90 of a wide range of mutually different products. In fact, the parameters of the welding operation can vary from one product to another, and can depend for example on the material of the conducting elements (for example copper or aluminum) or on the dimensions and geometries of the conducting elements to be welded together.

Preferably, the welding parameters and instructions for each product to be made are preset in an electronic control unit 20. For example, one of the parameters for welding conducting elements is the number of rotations, or scans, along a substantially circular path, to be made with the laser welding beam 86 on the surfaces of the ends of the conducting elements. Typically, the number of rotations or scans of the laser welding beam 86 required by the welding operation increases with the cross-section of the conducting elements to be welded together. The variation of these parameters and of these instructions from one product to another has an influence on the duration of the various phases 74 of the welding operation, and consequently also on the subdivision in the plurality of time periods #1-#6 of the welding operation, as well as on the time windows 76 used to control the quality of the weld 90.

It is also to be noted that, although the graphs in FIG. 4a show the trend of the reference signals 50-52, for an optical sensor device 12 associated with the welding head, and the graphs in FIG. 4b show the trend of the reference signals 53, 54, for an optical sensor device 14 associated with the source of the laser welding beam 86, the graphs of the subsequent FIGS. 5, 7a to 8b, 11, 12 and 15 to 18 are limited to the trend of the signals for an optical sensor device 12 associated with the welding head solely for the sake of simplicity of description.

With reference to FIG. 1, in an embodiment, the system of welding for inductive windings of electrical machines according to the present invention, generally designated by the reference numeral 10, comprises substantially at least one optical sensor device 12, 14, preferably of the photodiode type, and an electronic control unit 20. The at least one optical sensor device 12, 14 and the electronic control unit 20 are mutually connected and in communication. In other words, the at least one optical sensor device 12, 14 and the electronic control unit 20 are operatively connected to each other.

Conveniently, the system 10 according to the invention further comprises an electrical panel 16. The at least one optical sensor device 12, 14 and the electronic control unit 20 are mutually connected and in communication via the electrical panel 16.

The optical sensor device 12, 14 is configured to detect and acquire an optical emission 83 originating from the weld 90, during each welding operation. The optical sensor device 12, 14 is further configured to obtain at least one real signal 60-72 from the optical emission 83 of the weld 90, for each made product. In other words, this real signal 60-72 depends on the specific made product. It should be noted that, as mentioned, each product is characterized for example by the material of the conducting elements (for example copper or aluminum) or by the dimensions and geometries of the conducting elements to be welded together. The real signal 60-72 can be a time trend constituted by one of either a continuous time series or a plurality of consecutive discrete values of a discrete time series. Preferably, the real signal 60-72 of the optical emission 83 of the weld 90 is digital.

In an embodiment, the optical sensor device 12, 14 is configured to detect and acquire a radiation beam generated by the welding operation of the weld 90 by way of a laser welding beam 86, this radiation beam being comprised in the above-described optical emission 83. In this embodiment, the optical sensor device 12, 14 is further configured to obtain a real plasma signal 60, 63, 66, 69 from the radiation beam comprised in the optical emission 83 of the weld 90, this real plasma signal 60, 63, 66, 69 being in the visible field. In this embodiment, the optical sensor device 12, 14 is further configured to obtain a real thermal signal 61, 64, 67, 70, 72 from the radiation beam comprised in the optical emission 83 of the weld 90, this real thermal signal 61, 64, 67, 70, 72 being in the far infrared field.

In an embodiment, the optical sensor device 12, 14 is configured to detect and acquire a reflection beam of a laser welding beam 86 projected on the weld 90 during the welding operation, this reflection beam being comprised in the above-described optical emission 83. Basically, the reflection beam is the portion of the laser welding beam 86 that is reflected by the weld 90. In this embodiment, the optical sensor device 12, 14 is further configured to obtain a real back-reflection signal 62, 65, 68, 71 from the reflection beam comprised in the optical emission 83 of the weld 90, this real back-reflection signal 62, 65, 68, 71 being in the near-infrared field.

In an optimal embodiment, the optical sensor device 12, 14 is configured to detect and acquire both the radiation beam and the reflection beam comprised in the optical emission 83 of the weld 90. In this optimal embodiment, the optical sensor device 12, 14 is further configured to obtain both the real plasma signal 60, 63, 66, 69 and the real thermal signal 61, 64, 67, 70, 72 from the radiation beam comprised in the optical emission 83 of the weld 90, and also the real back-reflection signal 62, 65, 68, 71 from the reflection beam comprised in the optical emission 83 of the weld 90.

In an embodiment that comprises a plurality of optical sensor devices 12, 14 (for example two), each optical sensor device 12, 14 is configured to detect and acquire a respective optical emission 83 of the weld 90. Basically, the optical emission 83 detected by one optical sensor device 12 may be different from the optical emission 83 detected by another optical sensor device 14.

In this embodiment that comprises a plurality of optical sensor devices 12, 14 (for example two), each optical sensor device 12, 14 is configured to obtain at least one respective real signal 60-72 from the respective optical emission 83.

In an embodiment that comprises a plurality of optical sensor devices 12, 14 (for example two), each optical sensor device 12, 14 is configured to detect and acquire a respective radiation beam and/or a respective reflection beam comprised in the optical emission 83 of the weld 90. The radiation beam and/or the reflection beam detected by one optical sensor device 12 may be different from the radiation beam and/or from the reflection beam detected by another optical sensor device 14.

In this embodiment that comprises a plurality of optical sensor devices 12, 14 (for example two), each optical sensor device 12, 14 is configured to obtain a respective real plasma signal 60, 63, 66, 69 from the respective radiation beam comprised in the optical emission 83 of the weld 90 and/or a respective real thermal signal 61, 64, 67, 70, 72 from the respective radiation beam comprised in the optical emission 83 of the weld 90 and/or a respective real back-reflection signal 62, 65, 68, 71 from the respective reflection beam comprised in the optical emission 83 of the weld 90. The real plasma signal and/or the real thermal signal and/or the real back-reflection signal obtained by one optical sensor device 12 may be different from the real plasma signal and/or from the real thermal signal and/or from the real back-reflection signal obtained by another optical sensor device 14.

In an embodiment, the optical sensor device 12, 14 is associated with, for example arranged or installed at, the welding head of the welding machine, this welding head being arranged proximate to, or rather in view of, the pair of ends 88a, 88b of conducting elements to be welded, and therefore of the weld 90.

In an embodiment, the optical sensor device 12, 14 is associated with, for example arranged or installed at, the source of the laser welding beam 86 of the welding machine.

With reference to FIG. 1, in an optimal embodiment, the system 10 according to the invention comprises a first optical sensor device 12 associated with the welding head of the welding machine, and a second optical sensor device 14 associated with the source of the laser welding beam 86 of the welding machine.

Preferably, the optical sensor device 12 comprises one photodiode 21 for each real signal 60-72 to be obtained. Thus, in a complete embodiment, the optical sensor device 12 is configured to detect and acquire both the radiation beam and the reflection beam comprised in the optical emission 83 of the weld 90, and to obtain:
the real plasma signal 60, 63, 66, 69, via the first photodiode 21a, from the radiation beam comprised in the optical emission 83 of the weld 90;
the real thermal signal 61, 64, 67, 70, 72, via the second photodiode 21b, from the radiation beam comprised in the optical emission 83 of the weld 90; and
the real back-reflection signal 62, 65, 68, 71, via the third photodiode 21c, from the reflection beam comprised in the optical emission 83 of the weld 90.

With reference to FIG. 2, in an embodiment, the optical sensor device 12, arranged at the welding head of the welding machine, comprises an optical path that extends from a programmable focusing optic (in short: PFO) scanner 33 to a plurality of photodiodes 21. In particular, in this embodiment, the optical sensor device 12 comprises: three photodiodes 21 (one for each real signal 60-72 to be obtained), three respective focal lenses 22 (one for each photodiode 21), three respective optical filters 23 (one for each photodiode 21), a pair of beam splitters 24, a signal amplifier group 25, a signal acquisition system 26, a pair of mirrors 27, an additional beam splitter 28, a viewing system (for example a video camera) 29, a dichroic mirror 30, a collimation lens 31, an optic fiber 32 connected to the source of the laser welding beam 86, a programmable focusing optic scanner 33, and a focal (preferably F-Theta) lens 34.

Preferably, the three photodiodes 21, and consequently the three respective focal lenses 22 and the three respective optical filters 23, of the optical sensor device 12 are arranged coaxially to the vision system 29 of that same optical sensor device 12.

Also with reference to FIG. 2, in this embodiment of the optical sensor device 12, during the welding operation, the laser welding beam 86 comes from its respective source through the optic fiber 32, then passes through the collimation lens 31 and the dichroic mirror 30, until it reaches the programmable focusing optic scanner 33. Then the programmable focusing optic scanner 33 projects the laser welding beam 86 onto the pair of ends 88a, 88b of conducting elements to be welded, and thus onto the weld 90, through the focal lens 34. Then the programmable focusing optic scanner 33 detects the optical emission 83 of the weld 90, again through the focal lens 34. Then the optical emission 83 passes through, in order, the dichroic mirror 30, the beam splitter 28, the pair of mirrors 27, the pair of beam splitters 24, the three optical filters 23, the three focal lenses 22, until it reaches the three photodiodes 21.

Preferably, the optical sensor device 14 comprises one photodiode 36 for each real signal to be obtained. Thus, in a complete embodiment, the optical sensor device 14 is configured to detect and acquire both the radiation beam and the reflection beam comprised in the optical emission 83 of the weld 90, and to obtain:
the real plasma signal, via the first photodiode 36a, from the radiation beam comprised in the optical emission 83 of the weld 90;
the real thermal signal, via the second photodiode 36b, from the radiation beam comprised in the optical emission 83 of the weld 90; and
the real back-reflection signal, via the third photodiode 36c, from the reflection beam comprised in the optical emission 83 of the weld 90.

With reference to FIG. 3, in an embodiment, the optical sensor device 14, arranged at the source of the laser welding beam 86 of the welding machine, comprises an optical path that extends from an optic fiber 45 to a plurality of photodiodes 36. In particular, in this embodiment, the optical sensor device 14 comprises: three photodiodes 36 (one for each real signal to be obtained), three respective focal lenses 37 (one for each photodiode 36), three respective optical filters 38 (one for each photodiode 36), a pair of beam splitters 39, a signal amplifier assembly 40, a signal acquisition system 41, three mirrors 42, a generator disk 43 for the laser welding beam 86 (for example, of the NIR type with a wavelength of 1,030 nm), a focal lens 44, and a fiber optic 45 connected to the welding head.

Again with reference to FIG. 3, in this embodiment of the optical sensor device 14, during the welding operation, the generator disk 43 generates the laser welding beam 86 (for example, of the NIR type with a wavelength of 1,030 nm), which then passes through two of the three mirrors 42 and the focal lens 44, and which finally is sent to the welding head through the optic fiber 45. Then the optical emission 83 of the weld 90 comes from the welding head through that same optic fiber 45, then passing through, in order, the focal lens 44, the three mirrors 42, the pair of beam splitters 39, the three optical filters 38, the three focal lenses 37, until finally it reaches the three photodiodes 36.

With reference to FIGS. 1, 2 and 3, in an optimal embodiment, the system 10 according to the invention comprises a first optical sensor device 12 associated with the welding head of the welding machine, and a second optical sensor device 14 associated with the source of the laser welding beam 86 of the welding machine.

In this optimal embodiment, the first optical sensor device 12 is configured to detect and acquire a respective radiation beam and a respective reflection beam comprised in the optical emission 83 of the weld 90, and to obtain:
a respective real plasma signal 60, 63, 66, 69 and a respective real thermal signal 61, 64, 67, 70, 72 from the respective radiation beam comprised in the optical emission 83 of the weld 90, and
a respective real back-reflection signal 62, 65, 68, 71 from the respective reflection beam comprised in the optical emission 83 of the weld 90.

In this optimal embodiment, the second optical sensor device 14 is configured to detect and acquire a respective radiation beam and a respective reflection beam comprised in the optical emission 83 of the weld 90, and to obtain:
a respective real plasma signal and a respective real thermal signal from the respective radiation beam comprised in the optical emission 83 of the weld 90, and
a respective real back-reflection signal from the respective reflection beam comprised in the optical emission 83 of the weld 90.

The optical sensor device 12, 14 is further configured to send the at least one real signal 60-72 to the electronic control unit 20. The electronic control unit 20 is configured to receive the at least one real signal 60-72 from the optical sensor device 12, 14.

Advantageously, the at least one real signal 60-72 is filtered, by the optical sensor device 12, 14 or by the electronic control unit 20, with a low-pass filter, preferably at 1000 Hz.

The electronic control unit 20 is the main operative element of the system 10 according to the invention, and for this reason the electronic control unit 20 is connected and in communication with the other elements comprised in the system 10 according to the invention.

The electronic control unit 20 of the system 10 according to the invention is provided with appropriate capabilities for processing and for interfacing with the other elements of the system 10. Moreover, the electronic control unit 20 is configured to command, control and coordinate the operation of the elements of the system 10 to which the electronic control unit 20 is connected and with which the same electronic control unit 20 is in communication.

The electronic control unit 20 is configured to compare the characteristics, for example the trend or the physical indicators, of the at least one real signal 60-72 of the optical emission 83 of the weld 90 with the characteristics, for example the trend or the physical indicators, of at least one respective reference signal 50-54 of the optical emission 83 of the weld 90, so identifying any defects and/or estimating mechanical properties of the weld 90 on the basis of the variation—or, more generally, the relationship—between the characteristics compared.

In other words, the electronic control unit 20 is configured to identify any defects and/or estimate mechanical properties of the weld 90, by evaluating the characteristics—for example, the trend or the physical indicators—of the at least one real signal 60-72 of the optical emission 83 of the weld 90 with respect to the characteristics—for example, the trend or the physical indicators—of the at least one respective reference signal 50-54 of the optical emission 83 of the weld 90.

Advantageously, the electronic control unit 20 is further configured to subdivide the at least one real signal 60-72 of the optical emission 83 of each welding operation into a plurality of signal portions, i.e. at least two signal portions, each of these portions of the real signal 60-72 having duration corresponding to a respective time window, this respective time window being defined by the electronic control unit 20.

Similarly, advantageously, the electronic control unit 20 is further configured to subdivide the at least one reference signal 50-54 of the optical emission 83 of each welding operation into a plurality of signal portions, i.e. at least two signal portions, each of these portions of the reference signal 50-54 having duration corresponding to a respective time window, this respective time window being defined (or established) by the electronic control unit 20.

Advantageously, following the above-described subdivision of the real signal 60-72 and of the reference signal 50-54, the electronic control unit 20 is further configured to compare each portion of the at least one real signal 60-72—the duration of which is, as mentioned, that of a respective time window—with a respective portion of the at least one reference signal 50-54—the duration of which is that of a corresponding time window—of the welding operation.

For example, basically, the portion of the real signal 60-72 that corresponds to the time window 76 is compared with the portion of the reference signal 50-54 that corresponds to the same time window 76, and so on.

As mentioned above, the characteristics of each one of the real signals 60-72 of the optical emission 83 of the weld 90 can be represented by a respective trend, or by one or more respective physical indicators. In short, each real signal 60-72 can be represented by a respective trend, or by one or more respective physical indicators.

Similarly, the characteristics of each one of the reference signals 50-54 of the optical emission 83 of the weld 90 can be represented by a respective trend, or by one or more respective physical indicators. In short, each reference signal 50-54 can be represented by a respective trend, or by one or more respective physical indicators.

In an embodiment, using the first method of representing the signals (i.e., the real signals 60-72 and the reference signals 50-54), the electronic control unit 20 is configured to compare the trend of the at least one real signal 60-72 of the optical emission 83 of the weld 90 with the trend of the at least one respective reference signal 50-54 of the optical emission 83 of the weld 90, so identifying any defects and/or estimating mechanical properties of the weld 90 on the basis of the variation, or more generally the relationship, between the compared trends.

In a preferred embodiment, using the second method of representing the signals, real signal 60-72 and reference signal 50-54, the electronic control unit 20 is configured to compare one or more physical indicators of the at least one real signal 60-72 of the optical emission 83 of the weld 90 with one or more physical indicators of the at least one respective reference signal 50-54 of the optical emission 83 of the weld 90, so identifying any defects and/or estimating mechanical properties of the weld 90 on the basis of the variation—or, more generally, the relationship—between the compared physical indicators.

The trend can be seen as a direct representation of the characteristics of a real signal 60-72 or of a reference signal 50-54. The physical indicators can be seen as an indirect representation of the characteristics of a real signal 60-72 or of a reference signal 50-54.

The physical indicators can be seen as an indirect representation of the characteristics of a real signal 60-72 or of a reference signal 50-54 because the physical indicators are extracted from the actual real signals 60-72 or reference signals 50-54 of the optical emission 83 of the weld 90 according to the methods described in detail below.

It is to be noted that the physical indicators are dimensionless.

Preferably, the comparison or the evaluation described above are executed by the electronic control unit 20 taking into account a predefined tolerance band 55-59, for example of breadth ±20%. The breadth of the tolerance band 55-59 mentioned above determines the sensitivity of identification of defects in the weld 90.

The reference signal 50-54 of the optical emission 83 of the weld 90 is the typical signal of the optical emission 83 of a weld 90 of good or sufficient quality—and thus of a weld 90 free from defects—for each product to be made. In other words, this reference signal 50-54 depends on the specific product to be made. It should be noted that, as mentioned, each product is characterized for example by the material of the conducting elements (for example copper or aluminum) or by the dimensions and geometries of the conducting elements to be welded together. Preferably, the reference signal 50-54 of the optical emission 83 of the weld 90 is digital.

The reference signal 50-54 of the optical emission 83 of the weld 90 must be predefined. Preferably, the reference signal 50-54 is defined by means of a campaign (i.e. a plurality) of controlled tests, which is designed to define said reference signal and is executed by the welding machine, during which a plurality of respective real signals is measured. Basically, a reference plasma signal 50, 53 is defined on the basis of a plurality of real plasma signals measured during the campaign of controlled tests. Similarly, a reference thermal signal 51, 54 is defined on the basis of a plurality of real thermal signals measured during the campaign of controlled tests. Also similarly, a reference back-reflection signal 52 is defined on the basis of a plurality of real back-reflection signals measured during the campaign of controlled tests.

Preferably, the reference signal 50-54 is defined by averaging—i.e. by calculating the average of—a plurality of respective real signals measured during the campaign of controlled tests. Basically, for each moment in time, the value of the reference signal 50-54 is defined by calculating the average value of the plurality of values of the respective real signals measured during the campaign of controlled tests.

Preferably, in order to define the reference signal 50-54, the campaign of controlled tests of the welding machine is executed with welding parameters that are constant. The characteristics—for example, the trend or the physical indicators—of the reference signal 50-54 depend strongly on the welding parameters; therefore, every time these parameters are modified, it is necessary to redefine a new reference signal with a new campaign of controlled tests.

In an embodiment comprising a plurality of optical sensor devices 12, 14 (for example two), each optical sensor device 12, 14 is associated with at least one respective reference signal 50-54.

In an embodiment comprising a plurality of optical sensor devices 12, 14 (for example two), each optical sensor device 12, 14 is associated with a respective reference plasma signal 50, 53 and/or a respective reference thermal signal 51, 54 and/or a respective reference back-reflection signal 52.

As mentioned, in an embodiment, the system 10 according to the invention can comprise a first optical sensor device 12 associated with the welding head of the welding machine, and a second optical sensor device 14 associated with the source of the laser welding beam 86 of the welding machine.

With reference to FIGS. 4a and 4b, in an embodiment, a first reference plasma signal 50, a first reference thermal signal 51, and a reference back-reflection signal 52 relate to the optical sensor device 12 associated with the welding head of the welding machine, while a second reference plasma signal 53 and a second reference thermal signal 54 relate to the optical sensor device 14 associated with the source of the laser welding beam 86 of the welding machine.

It is to be noted that the reference plasma signal 50, 53 and the reference thermal signal 51, 54 are intense and reflect the cyclic movement, along a substantially circular path, of the laser welding beam 86 visible with the periodic increase of their intensity, while the reference back-reflection signal 52 is more stable.

In a preferred embodiment, the electronic control unit 20 is configured to extract one or more physical indicators from the at least one real signal 60-72 of the optical emission 83 of the weld 90. Similarly, in the same preferred embodiment, the electronic control unit 20 is configured to extract one or more physical indicators from the at least one reference signal 50-54 of the optical emission 83 of the weld 90.

In a preferred embodiment, the electronic control unit 20 is configured to extract one or more physical indicators from a real plasma signal 60, 63, 66, 69 of the optical emission 83 of the weld 90. Similarly, in the same embodiment, the electronic control unit 20 is configured to extract one or more physical indicators from a reference plasma signal 50, 53 of the optical emission 83 of the weld 90.

In a preferred embodiment, the electronic control unit 20 is configured to extract one or more physical indicators from a real thermal signal 61, 64, 67, 70, 72 of the optical emission 83 of the weld 90. Similarly, in the same preferred embodiment, the electronic control unit 20 is configured to extract one or more physical indicators from a reference thermal signal 51, 54 of the optical emission 83 of the weld 90.

In a preferred embodiment, the electronic control unit 20 is configured to extract one or more physical indicators from a real back-reflection signal 62, 65, 68, 71 of the optical emission 83 of the weld 90. Similarly, in the same preferred embodiment, the electronic control unit 20 is configured to extract one or more physical indicators from a reference back-reflection signal 52 of the optical emission 83 of the weld 90.

Basically, the physical indicators are physically-driven indicators, or physics-informed indicators, which enable identification of physical phenomena that arise during the welding operation to bond the pair of ends 88a, 88b of the conducting elements, in specific time periods #1-#6 and/or in specific time windows 76.

These physical indicators are relevant to the welding operation to bond the pair of ends 88a, 88b of the conducting elements, in particular for the specific welding strategy that comprises a respective, substantially circular, path of rotation or scanning (where, as mentioned, these two terms are to be understood as synonyms) of the laser welding beam 86.

Each physical indicator relates to a respective signal which is a real signal or a reference signal. In more detail, each physical indicator relates to a respective portion of the above-mentioned respective signal—and therefore to a time window 76 related to a respective phase 74 of the welding operation to bond the pair of ends 88a, 88b of the conducting elements—corresponding to the above-mentioned respective portion of the respective signal.

In FIGS. 7a, 7b, 8a, 8b, 11 and 12, each time window 76 is defined by an initial moment in time and a final moment in time, indicated respectively by the left-hand end and by the right-hand end of the curly brackets indicating the respective physical indicators.

The identification and subsequent extraction of the physical indicators, performed by the electronic control unit 20, is based on the observation of the characteristics of the respective signal—which is a real signal or a reference signal—in specific time windows 76 related to respective phases 74 of the welding operation to bond the pair of ends 88a, 88b of the conducting elements.

It should be noted that each time window 76 mentioned above relates to a respective phase 74 of the welding operation. Conversely, each phase 74 of the welding operation mentioned above relates to a respective time window 76.

As a consequence, each portion of the real signal 60-72 or reference signal 50-54 contained in the respective time window 76 relates to a respective phase 74 of the welding operation mentioned above. Conversely, each phase 74 of the welding operation mentioned above relates to a respective portion of the real signal 60-72 or reference signal 50-54 contained in the respective time window 76.

With reference to FIG. 5, the welding operation to bond the pair of ends 88a, 88b of the conducting elements can be subdivided schematically into six phases 74, in particular: initial conditions phase 74a, first laser-Cu interaction phase 74b, bridging gap phase 74c, second laser-Cu interaction phase 74d, melt formation phase 74e, and melt cooling and solidification phase 74F. It is to be noted that copper is given above solely as an example and, therefore, can be substituted by any other material of which the conducting elements are made.

FIG. 5 shows the correlation between the above-mentioned phases 74, 74a-74f of the welding operation to bond the pair of ends 88a, 88b of the conducting elements, each one accompanied by a respective schematic diagram 75, 75a-75f and the respective portions of the reference thermal signal 51 of the optical emission 83 of the weld 90. It should be noted that, as mentioned, the variation of the welding parameters and of the welding instructions from one product to another has an influence on the duration of the various phases 74 of the welding operation, and consequently also on the subdivision in the plurality of time periods #1-#6 of the welding operation, as well as on the time windows 76 used to control the quality of the weld 90.

In general, a real signal 60-72 or reference signal 50-54 of the optical emission 83 of the weld 90 can be defined as a time-variable intensity I(t) at different moments in time t.

In general, a physical indicator can be defined as the energy E of a respective real signal 60-72 or reference signal 50-54 inside a respective time window 76, comprised between a preset initial time (or rather, moment in time) tₛₜₐᵣₜ and a preset final time (or rather, moment in time) t_{end}. Each time window 76 relates to at least one respective phase 74 of the welding operation, the duration of this phase 74 varying on the basis of the specific product to be made. In other words, a physical indicator is defined as the energy E of a respective portion of the real signal 60-72 or reference signal 50-54, each signal portion being contained inside a respective time window 76, and each signal portion relating to at least one respective phase 74 of the welding operation.

As mentioned, in a preferred embodiment, the electronic control unit 20 is configured to extract one or more physical indicators from the at least one real signal 60-72 or reference signal 50-54 of the optical emission 83 of the weld 90.

Conveniently, using a first method of extraction of the physical indicators of a signal, the electronic control unit 20 is configured to extract each of the physical indicators by calculating the energy E of a respective real signal 60-72 or reference signal 50-54 inside a respective time window 76, i.e. inside a respective portion of real signal 60-72 or reference signal 50-54 contained in a respective time window 76, by calculating the integral of the time-variable intensity I(t) from an initial moment in time tₛₜₐᵣₜ to a final moment in time t_{end} of that time window 76, according to the following mathematical formula:

$${YE}_{positionX} = {\int }_{{t}_{start}}^{{t}_{end}} I ( t ) dt$$

where:
   “E” is the overall energy of the real signal 60-72 or reference signal 50-54 inside a time window 76;
   “Y” is a variable that indicates the type of real signal 60-72 or reference signal 50-54 observed, wherein this variable “Y” can be “P” for a real plasma signal 60, 63, 66, 69 or reference plasma signal 50, 53, “T” for a real thermal signal 61, 64, 67, 70, 72 or reference thermal signal 51, 54, and “B” for a real back-reflection signal 62, 65, 68, 71 or reference back-reflection signal 52;
   “positionX” is a variable that indicates, qualitatively, the time window 76, i.e. a specific phase 74 of the welding operation, and therefore the time domain in which the integral is calculated;
   “I(t)” is the time-variable intensity of the real signal 60-72 or reference signal 50-54 of the optical emission 83 of the weld 90;
   “tₛₜₐᵣₜ” is the moment in time when the integral begins, or rather when the time domain in which the integral is calculated begins; and
   “t_{end}” is the moment in time when the integral ends, or rather when the time domain in which the integral is calculated ends.

FIG. 6a schematically shows the extraction of the physical indicators of a signal, real signal 60-72 or reference signal 50-54, of the optical emission 83 of the weld 90, using this first method of extraction.

However, considering that the real signal 60-72 and the reference signal 50-54 of the optical emission 83 of the weld 90 are preferably digital, the integral of the time-variable intensity I(t) from an initial moment in time tₛₜₐᵣₜ to a final moment in time t_{end} of the time window 76, in order to calculate the energy E of a respective real signal 60-72 or reference signal 50-54 inside that same time window 76, can be approximate.

Therefore, advantageously, using a second method of extraction of the physical indicators of a signal, the electronic control unit 20 is configured to extract each one of the physical indicators by calculating the energy E of a respective real signal 60-72 or reference signal 50-54 inside a respective time window 76, i.e. inside a respective portion of real signal 60-72 or reference signal 50-54 contained in a respective time window 76, by summing each instantaneous intensity Iᵢ from an initial moment in time tₛₜₐᵣₜ to a final moment in time t_{end}, multiplied by the sampling time Δt (or divided by the frequency of acquisition of the signal f_{acq}), according to the following mathematical formula:

$${YE}_{positionX} = Δ t \cdot {{\sum }_{i = {t}_{start}}}^{{t}_{end}} {I}_{i}$$

where:
   “E” is the overall energy of the real signal 60-72 or reference signal 50-54 inside a time window 76;
   “Y” is a variable that indicates the type of real signal 60-72 or reference signal 50-54 observed, wherein this variable “Y” can take the value “P” for a real plasma signal 60, 63, 66, 69 or reference plasma signal 50, 53, “T” for a real thermal signal 61, 64, 67, 70, 72 or reference thermal signal 51, 54, and “B” for a real back-reflection signal 62, 65, 68, 71 or reference back-reflection signal 52;
   “positionX” is a variable that indicates, qualitatively, the time window 76, i.e. a specific phase 74 of the welding operation, and therefore the time domain in which the sum is calculated;
   “Iᵢ” is the intensity of the real signal 60-72 or reference signal 50-54 of the optical emission 83 of the weld 90 at a specific moment in time i;
   “Δt” is the sampling time given by the temporal discretization imposed by the digital acquisition of the signal, which can be calculated as the reciprocal of the frequency of acquisition of the signal f_{acq} (i.e Δt=1/f_{acq});
   “tₛₜₐᵣₜ” is the moment in time when the summing begins, or rather when the time domain in which the sum is calculated begins; and
   “t_{end}” is the moment in time when the summing ends, or rather when the time domain in which the sum is calculated ends.

FIG. 6b schematically shows the extraction of the physical indicators of a signal, which is a real signal 60-72 or a reference signal 50-54, of the optical emission 83 of the weld 90, using this second method of extraction.

As mentioned, “positionX” is a variable that indicates, qualitatively, the time window 76, i.e. a specific phase 74 of the welding operation, and therefore the time domain in which the integral or the sum described above are calculated.

The various time windows 76 shown in FIGS. 7a, 7b, 8a, 8b, 11 and 12 via the curly brackets indicate the respective time domains in which the integral or the sum described above can be calculated.

In particular, the variable “positionX” can take, as a value:
“All” for the time window 76 that covers the entire welding operation of the pair of ends 88a, 88b of the conducting elements, and therefore all of the time domain;
“Start” for the initial time window 76 of the welding operation, indicatively the first half of the total period of emission of the laser welding beam 86, i.e. from the moment the laser welding beam 86 starts emitting to half-way through the total emission period of the same laser welding beam 86;
“Melt” for the time window 76 in which the melt forms during the welding operation, indicatively the second half of the total period of emission of the laser welding beam 86, i.e. from half-way through the total period of emission of the laser welding beam 86 to the moment when the laser welding beam 86 stops emitting;
“Proc” for the time window 76 in which the emission of the laser welding beam 86 is active during the welding operation;
“Solid” for the time window 76 of solidification of the melt during the welding operation, when the total period of emission of the laser welding beam 86 has ended and the melt proceeds to solidify;
“Gap_n” (for n=1: x, for example where x is equal to 8) for the time window 76 in which the laser welding beam 86 bridges the gap (jumps) between two conducting elements, by passing through free space, for the n-th time, during the welding operation;
“f3Gaps” for the three time windows 76 in which the laser welding beam 86 bridges the gap between two conducting elements, by passing through free space, during the welding operation;
“Turn_n” (for n=1: x, for example where x is equal to 5) for the time window 76 in which a complete rotation or scan of the laser welding beam 86 is performed above the conducting elements, for the n-th time, during the welding operation;
“f3Turns” for the time window 76 in which three complete rotations or scans of the laser welding beam 86 are performed above the conducting elements during the welding operation.

With reference to FIGS. 7a and 7b, preferably, the electronic control unit 20 is configured to extract, from a real thermal signal 61, 64, 67, 70, 72 and/or from a reference thermal signal 51, 54 of the optical emission 83 of the weld 90, using the first or the second method of extraction of physical indicators of a signal, one or more thermal signal physical indicators selected from the group consisting of:
TE_All;
TE_Start;
TE_Melt;
TE_Solid;
TE_Gap_n (for n=1: x, for example where x is equal to 8);
TE_f3Gaps.

Similarly to what is described above, preferably, the electronic control unit 20 is configured to extract, from a real plasma signal 60, 63, 66, 69 and/or from a reference plasma signal 50, 53 of the optical emission 83 of the weld 90, using the first or the second method of extraction of physical indicators of a signal, one or more plasma signal physical indicators selected from the group consisting of:
PE_All;
PE_Start;
PE_Melt;
PE_Solid;
PE_Gap_n (for n=1: x, for example where x is equal to 8);
PE_f3Gaps.

With reference to FIGS. 8a and 8b, preferably, the electronic control unit 20 is configured to extract, from a real back-reflection signal 62, 65, 68, 71 and/or from a reference back-reflection signal 52 of the optical emission 83 of the weld 90, using the first or the second method of extraction of physical indicators of a signal, one or more back-reflection signal physical indicators selected from the group consisting of:
BE_All;
BE_Proc;
BE_Solid;
BE_Turn_n (for n=1: x, for example where x is equal to 5);
BE_f3Turns.

As mentioned, the physical indicators extracted from the real signals 60-72 or reference signals 50-54 of the optical emission 83 of the weld 90 make it possible to identify physical phenomena that arise during the welding operation to bond the pair of ends 88a, 88b of the conducting elements, in specific time periods #1-#6 and/or in specific time windows 76, and therefore in specific phases 74 of the welding operation. It should be noted that, as mentioned, these real signals 60-72 or reference signals 50-54 depend on the specific product made or to be made. It should also be noted that, as mentioned, each product is characterized for example by the material of the conducting elements (for example copper or aluminum) or by the dimensions and geometries of the conducting elements to be welded together.

Therefore, these physical indicators can be used as direct indicators for the various defects of the weld 90, or at least a part of them, by establishing a direct relationship between one or more physical indicators and a defect of the weld 90.

Conveniently, the electronic control unit 20 is configured to receive as input one or more physical indicators of the real signals 60-72 of the optical emission 83 of the weld 90, determine at least one class of defect of the weld 90 according to the direct relationship described above, and produce as output the characterization of this at least one class of defect of the weld 90. Preferably, the electronic control unit 20 is further configured not to produce as output any characterization of a class in the absence of defects in the weld 90.

For example, with reference to FIG. 9, the physical indicator BE_f3Turns can be used as a direct indicator to evaluate the cleanliness of the protection window of the scanning head, for example of the Programmable Focusing Optic (PFO) type, and to identify the defect of dirt buildup on that same scanning head.

With reference to FIG. 9, it is possible to see a descending general shift 78 in the physical indicator BE_f3Turns used, and this general shift 78 is independent of the combination of the welding parameters.

Advantageously, the physical indicators can be used for machine learning. In particular, the physical indicators can be used as input data, first for training and then for the operation of at least one classification model, trained via at least one machine learning algorithm. The combined use of physical indicators and of the classification model, trained using the machine learning algorithm, makes it possible to identify anomalous situations, and therefore defects in the weld 90, with greater certainty.

In the training phase, the physical indicators, extracted from real signals 60-72 or reference signals 50-54, can be used to train the classification model, using the supervised machine learning approach shown schematically in FIG. 10.

Preferably, the real signals 60-72—from which the physical indicators used in this training are extracted—are produced with process variations which are set and which can be expected to arise during the welding operation, for example position, welding parameters (number of the rotation or scan, power, blurring, etc.), external influences (misalignment, gaps, quality of deinsulation, etc.).

As a consequence of the training phase—i.e. in the operating phase—using the classification model which is trained via the machine learning algorithm, it is possible to determine if a specific real signal 60-72, represented by one or more respective physical indicators, belongs to a specific class of defect of the weld 90, with a reduced margin of error.

Preferably, the accuracy of the classification model being trained via the machine learning algorithm is evaluated using confusion matrices.

Some examples of machine learning algorithms, which can be used in combination with physical indicators, can be: Support Vector Machine, Linear Discriminant Analysis, K-Nearest Neighbors (KNN) Classifier, Classification Tree. Among these algorithms, the most promising appears to be Support Vector Machine, which makes it possible to define the hyperplanes that separate the various classes of defect of the weld 90.

Advantageously, the electronic control unit 20 is configured to implement at least one classification model which is trained using at least one machine learning algorithm. This classification model is configured to receive as input one or more physical indicators of the real signals 60-72 of the optical emission 83 of the weld 90, determine at least one class of defect of the weld 90 according to the training described above, and produce as output the characterization of this at least one class of defect of the weld 90. Preferably, this classification model is further configured not to produce as output any characterization of a class in the absence of defects in the weld 90.

With reference to FIG. 11, in an embodiment, the electronic control unit 20 is configured to compare the characteristics, in particular the physical indicator TE_Solid, of the real thermal signal 72 with the characteristics, in particular the physical indicator TE_Solid, of the respective reference thermal signal 51, during the solidification phase of the weld 90 (t>≈0.25 s, time period #6), so identifying a defect of poor or insufficient internal porosity of the weld 90 on the basis of the variation—i.e. the difference—between the characteristics compared, preferably taking into account a predefined tolerance band, for example of breadth ±20%.

In other words, in this embodiment, the electronic control unit 20 is configured to identify a defect of poor or insufficient internal porosity of the weld 90, by evaluating the characteristics, in particular the physical indicator TE_Solid, of the real thermal signal 72 with respect to the characteristics, in particular the physical indicator TE_Solid, of the respective reference thermal signal 51, during the solidification phase of the weld 90 (t>≈0.25 s, time period #6).

With reference to FIG. 13:
for low values, for example lower than 14 (zone or area 1 of the graph), of the physical indicator TE_Solid, the internal porosity of the weld 90 is poor or insufficient;
for high values, for example higher than 14 (zone or area 3 of the graph), of the physical indicator TE_Solid, the internal porosity of the weld 90 is good or sufficient; and
for intermediate values, for example comprised between 14 and 28 (zone or area 2 of the graph), of the physical indicator TE_Solid, it is not possible to meaningfully identify the internal porosity of the weld 90.

With reference to FIG. 12, in an embodiment, the electronic control unit 20 is configured to compare the characteristics, in particular the physical indicator TE_All, of the real thermal signal 72 with the characteristics, in particular the physical indicator TE_All, of the respective reference thermal signal 51, during the entire welding operation, from the initial conditions phase to the solidification phase of the weld 90 (t>≈0 s, time periods #1 and following), so identifying a defect of poor or insufficient mechanical strength (pull-out force) in the weld 90 on the basis of the variation, i.e. the difference, between the characteristics compared, preferably taking into account a predefined tolerance band, for example of breadth ±20%.

In other words, in this embodiment, the electronic control unit 20 is configured to identify a defect of poor or insufficient mechanical strength (pull-out force) in the weld 90, by evaluating the characteristics, in particular the physical indicator TE_All, of the real thermal signal 72 with respect to the characteristics, in particular the physical indicator TE_All, of the respective reference thermal signal 51, during the entire welding operation, from the initial conditions phase to the solidification phase of the weld 90 (t>≈0 s, time periods #1 and following).

In particular, the mechanical strength (pull-out force) of the weld 90 is in a direct relationship with the physical indicator TE_All of the real thermal signal 72 according to the following nonlinear regression formula, as a function of 3 dimensionless coefficients A, k and D which can be obtained by means of a preliminary campaign of controlled tests:

$$F = A + \frac{k}{{( {TE}_{ALL} )}^{D}}$$

With reference to FIG. 14, for example, if the threshold value of the mechanical strength (pull-out force) of the weld 90 is equal to 200 N, the reference value of the physical indicator TE_All can be equal to 10,000. It should be noted that the physical indicators, and therefore also TE_All, are dimensionless; therefore, they can vary according to the welding parameters.

With reference to FIG. 15, in an embodiment, the electronic control unit 20 is configured to compare the characteristics, for example the trend or the physical indicators, of the real back-reflection signal 62 with the characteristics, for example the trend or the physical indicators, of the respective reference back-reflection signal 52, so identifying a defect of poor or insufficient volume of the weld 90, owing to lack of power of the laser welding beam 86, on the basis of the variation, i.e. the difference, between the characteristics compared, preferably taking into account a predefined tolerance band 57, for example of breadth ±20%.

In other words, in this embodiment, the electronic control unit 20 is configured to identify a defect of poor or insufficient volume of the weld 90, owing to lack of power of the laser welding beam 86, by evaluating the characteristics, for example the trend or the physical indicators, of the real back-reflection signal 62 with respect to the characteristics, for example the trend or the physical indicators, of the respective reference back-reflection signal 52, preferably taking into account a predetermined tolerance band 57, for example of breadth ±20%.

In particular, in this embodiment, the electronic control unit 20 identifies a defect of poor or insufficient volume of the weld 90, owing to lack of power of the laser welding beam 86, when the characteristics, for example the trend or the physical indicators, of the real back-reflection signal 62 tend to remain below the characteristics, for example the trend or the physical indicators, of the respective reference back-reflection signal 52 for the entire duration of the welding operation, preferably taking into account a predetermined tolerance band 57, for example of breadth ±20%.

With reference to FIG. 16, in an embodiment, the electronic control unit 20 is configured to compare the characteristics, for example the trend or the physical indicators, of the real back-reflection signal 65 with the characteristics, for example the trend or the physical indicators, of the respective reference back-reflection signal 52, so identifying a defect of poor or insufficient volume of the weld 90, owing to loss of focal position of the laser welding beam 86, on the basis of the variation, i.e. the difference, between the characteristics compared, preferably taking into account a predefined tolerance band 57, for example of breadth ±20%.

In other words, in this embodiment, the electronic control unit 20 is configured to identify a defect of poor or insufficient volume of the weld 90, owing to loss of focal position of the laser welding beam 86, by evaluating the characteristics, for example the trend or the physical indicators, of the real back-reflection signal 65 with respect to the characteristics, for example the trend or the physical indicators, of the respective reference back-reflection signal 52, preferably taking into account a predetermined tolerance band 57, for example of breadth ±20%.

In particular, in this embodiment, the electronic control unit 20 identifies a defect of poor or insufficient volume of the weld 90, owing to loss of focal position of the laser welding beam 86, when the characteristics, for example the trend or the physical indicators, of the real back-reflection signal 65 tend to remain above the characteristics, for example the trend or the physical indicators, of the respective reference back-reflection signal 52 for the entire duration of the welding operation, preferably taking into account a predetermined tolerance band 57, for example of breadth ±20%.

With reference to FIG. 17, in an embodiment, the electronic control unit 20 is configured to compare the characteristics, for example the trend or the physical indicators, of the real plasma signal 66 and/or of the real thermal signal 67, preferably of a combination of the real plasma signal 66 and of the real thermal signal 67, with the characteristics, for example the trend or the physical indicators, of the respective reference plasma signal 50 and/or of the respective reference thermal signal 51, preferably of a combination of the respective reference plasma signal 50 and of the respective reference thermal signal 51, so identifying a defect of poor or insufficient quality of deinsulation of the conducting elements on the basis of the variation, i.e. the difference, between the compared characteristics, preferably taking into account a predefined tolerance band 55, 56, for example of breadth ±20%.

In other words, in this embodiment, the electronic control unit 20 is configured to identify a defect of poor or insufficient quality of deinsulation of the conducting elements, by evaluating the characteristics, for example the trend or the physical indicators, of the real plasma signal 66 and/or of the real thermal signal 67, preferably of a combination of the real plasma signal 66 and of the real thermal signal 67, with respect to the characteristics, for example the trend or the physical indicators, of the respective reference plasma signal 50 and/or of the respective reference thermal signal 51, preferably of a combination of the respective reference plasma signal 50 and of the respective reference thermal signal 51, preferably taking into account a predefined tolerance band 55, 56, for example of breadth ±20%.

In particular, in this embodiment, the electronic control unit 20 identifies a defect of poor or insufficient quality of deinsulation of the conducting elements when the characteristics, for example the trend or the physical indicators, of the real plasma signal 66 and/or of the real thermal signal 67, preferably of a combination of the real plasma signal 66 and of the real thermal signal 67, tend to differ greatly from the characteristics, for example the trend or the physical indicators, of the respective reference plasma signal 50 and/or of the respective reference thermal signal 51, preferably of a combination of the respective reference thermal signal 50 and of the respective reference thermal signal 51, starting from the transition phase of the welding operation (t>≈0.1 s, time periods #3, #4, #5 and #6), preferably taking into account a predefined tolerance band 55, 56, for example of breadth ±20%.

With reference to FIG. 18, in an embodiment, the electronic control unit 20 is configured to compare the characteristics, for example the trend or the physical indicators, of the real plasma signal 69 and/or of the real thermal signal 70, preferably of a combination of the real plasma signal 69 and of the real thermal signal 70, with the characteristics, for example the trend or the physical indicators, of the respective reference plasma signal 50 and/or of the respective reference thermal signal 51, preferably of a combination of the respective reference plasma signal 50 and of the respective reference thermal signal 51, so identifying a defect of explosion of the weld 90 on the basis of the variation, i.e. the difference, between the characteristics compared, preferably taking into account a predefined tolerance band 55, 56, this tolerance band 55, 56 being broader than the band for the defect of poor or insufficient quality of deinsulation of the conducting elements.

In other words, in this embodiment, the electronic control unit 20 is configured to identify a defect of explosion of the weld 90, by evaluating the characteristics, for example the trend or the physical indicators, of the real plasma signal 69 and/or of the real thermal signal 70, preferably of a combination of the real plasma signal 69 and of the real thermal signal 70, with respect to the characteristics, for example the trend or the physical indicators, of the respective reference plasma signal 50 and/or of the respective reference thermal signal 51, preferably of a combination of the respective reference plasma signal 50 and of the respective reference thermal signal 51, preferably taking into account a predefined tolerance band 55, 56, this tolerance band 55, 56 being broader than the band for the defect of poor or insufficient quality of deinsulation of the conducting elements.

In particular, in this embodiment, the electronic control unit 20 identifies a defect of explosion of the weld 90 when the characteristics, for example the trend or the physical indicators, of the real plasma signal 66 and/or of the real thermal signal 67, preferably of a combination of the real plasma signal 66 and of the real thermal signal 67, tend to differ greatly from the characteristics, for example the trend or the physical indicators, of the respective reference plasma signal 50 and/or of the respective reference thermal signal 51, preferably of a combination of the respective reference thermal signal 50 and of the respective reference thermal signal 51, starting from the transition phase of the welding operation (t>≈0.1 s, time periods #3, #4, #5 and #6), preferably taking into account a predefined tolerance band 55, 56, this tolerance band 55, 56 being broader than the band for the defect of poor or insufficient quality of deinsulation of the conducting elements.

In an embodiment, the electronic control unit 20 comprises a memory (not shown) configured to store the at least one reference signal 50-54 of the optical emission 83 of the weld 90 which can be compared with the at least one real signal 60-72 of the optical emission 83 of the weld 90. In an embodiment, the memory of the electronic control unit 20 is configured to store at least one reference plasma signal 50, 53 which can be compared with at least one respective real plasma signal 60, 63, 66, 69. In an embodiment, the memory of the electronic control unit 20 is configured to store at least one reference thermal signal 51, 54 which can be compared with at least one respective real thermal signal 61, 64, 67, 70, 72. In an embodiment, the memory of the electronic control unit 20 is configured to store at least one reference back-reflection signal 52 which can be compared with at least one respective real back-reflection signal 62, 65, 68, 71. In an optimal embodiment, the memory of the electronic control unit 20 is configured to store at least one reference plasma signal 50, 53 which can be compared with at least one respective real plasma signal 60, 63, 66, 69, at least one reference thermal signal 51, 54 which can be compared with at least one respective real thermal signal 61, 64, 67, 70, 72, and at least one reference back-reflection signal 52 which can be compared with at least one respective real back-reflection signal 62, 65, 68, 71.

With reference to FIGS. 4a and 4b, in an embodiment, the memory of the electronic control unit 20 is configured to store the first reference plasma signal 50, the first reference thermal signal 51, the reference back-reflection signal 52, the second reference plasma signal 53, and the second reference thermal signal 54.

Advantageously, the system 10 according to the invention further comprises a display device 18. The display device 18 and the electronic control unit 20 are mutually connected and in communication. In other words, the display device 18 and the electronic control unit 20 are operatively connected to each other.

The display device 18 is configured to display the at least one real signal obtained from the optical emission 83 of the weld 90, optionally filtered with the low-pass filter. Advantageously, the display device 18 is further configured to display the at least one reference signal.

In an optimal embodiment, the display device 18 is configured to display both the at least one real signal 60-72 obtained from the optical emission 83 of the weld 90 and also the respective at least one reference signal 50-54. Basically, the display device 18 can display one or more pairs of signals selected from the group consisting of: the real plasma signal and the reference plasma signal; the real thermal signal and the reference thermal signal; and the real back-reflection signal and the reference back-reflection signal.

The operation of the system 10 described above, i.e. the method of welding for inductive windings of electrical machines according to the present invention, comprises substantially the steps described below.

Preliminarily, it is to be noted that the method of welding according to the invention starts from U-shaped conducting elements with a bridge joining a pair of substantially straight shanks, wherein the conducting elements are arranged in a ferromagnetic core of an electrical machine with the shanks oriented parallel to an axis of symmetry of the ferromagnetic core, and wherein each shank of the conducting elements comprises an end 88a, 88b, each end 88a, 88b being adjacent to an end 88a, 88b of another conducting element for welding together according to a predefined electrical connection diagram.

In detail, the method according to the invention comprises the steps of:
arranging the ferromagnetic core containing the conducting elements in a welding zone, with the ends 88a, 88b of the conducting elements facing a programmable focusing optic scanner 33 controlled by an electronic control unit 20 and configured to project a laser welding beam 86;
gripping the ends 88a, 88b to be welded together, which are mutually adjacent and aligned, an axial interspace of separation being leaved between the ends 88a, 88b;
scanning the laser welding beam 86, by following a preset cyclic path passing through at least one first end 88a and at least one second end 88b of the conducting elements, wherein the preset path is scanned for a plurality of cycles, for the generation of a well of molten metal in the first and second ends 88a, 88b in order to close the interspace that separates them, each cycle of the scan having a preset duration #1-#5;
cooling the well of molten metal, by means of shutting off the laser welding beam 86, up until solidification of the well of molten metal, this solidification resulting in a weld 90 that stably, physically and electrically connects the first and second ends 88a, 88b of the adjacent conducting elements, the cooling having a preset duration #6;
monitoring at least one real signal 60-72 of an optical emission 83 in the steps of scanning and cooling in order to control the quality of the weld 90 between the pair of ends 88a, 88b of the conducting elements of an inductive winding of a stator, via at least one optical sensor device 12, 14 and the electronic control unit 20.

Further, the step of monitoring mentioned above comprises the steps of:
detecting and acquiring the optical emission 83 originating from the weld 90 for the duration #1-#5, #6 of the steps of scanning and cooling of each welding operation between the pair of ends 88a, 88b of the conducting elements;
obtaining at least one real signal 60-72 from the optical emission 83, the real signal 60-72 being a time trend constituted by one of either a continuous time series or a plurality of consecutive discrete values of a discrete time series;
comparing characteristics of the at least one real signal 60-72 of the optical emission 83 with respective characteristics of at least one respective reference signal 50-54 of the optical emission 83, and identifying defects of the weld 90 on the basis of the relationship between the compared characteristics; and
classifying the at least one real signal 60-72 on the basis of the comparison of the characteristics of the at least one real signal 60-72 with the respective characteristics of the at least one respective reference signal 50-54, wherein the classifying of the at least one real signal 60-72 includes identifying any defects and/or estimating mechanical properties of the weld 90 on the basis of the single relationship between the compared characteristics.

Furthermore, before the steps of scanning and cooling, the method further comprises the step of:
selecting a predefined welding program, wherein the welding program comprises, and thus defines: instructions and operating parameters with which the electronic control unit 20 is to execute the steps of scanning and cooling; at least one reference signal 50-54 of the optical emission 83 relating to the welding program; and at least one time window 76 for monitoring in the steps of scanning and cooling corresponding to a phase 74, 74a-74f of the welding operation.

The time window 76 corresponds to a specific phase 74 of the welding operation to bond the pair of ends 88a, 88b of the conducting elements. As mentioned, with reference to FIG. 5, the welding operation can be schematically subdivided into six phases 74, in particular: initial conditions phase 74a, first laser-Cu interaction phase 74b, bridging gap phase 74c, second laser-Cu interaction phase 74d, melt formation phase 74e, and melt cooling and solidification phase 74F. It is to be noted that copper is given above solely as an example and, therefore, can be substituted by any other material of which the conducting elements are made.

Furthermore, the above-described step of monitoring further comprises, before the step of comparing, the steps of:
extracting values corresponding to the phase 74, 74a-74f defined by the at least one time window 76 from the at least one real signal 60-72 of the optical emission 83 and from the at least one respective reference signal 50-54 of the optical emission 83 of each welding operation; and
calculating at least one physical indicator TE_All, TE_Start, TE_Melt, TE_Solid, TE_Gap_n, TE_f3Gaps, PE_All, PE_Start, PE_Melt, PE_Solid, PE_Gap_n, PE_f3Gaps, BE_All, BE_Proc, BE_Solid, BE_Turn_n, BE_f3Turns relating to the phase 74, 74a-74f of the welding operation, starting from the values which are contained in the at least one time window 76 and extracted from the at least one real signal 60-72 and from the at least one respective reference signal 50-54.

Furthermore, the above-described step of comparing further comprises the step of:
comparing the at least one physical indicator TE_All, TE_Start, TE_Melt, TE_Solid, TE_Gap_n, TE_f3Gaps, PE_All, PE_Start, PE_Melt, PE_Solid, PE_Gap_n, PE_f3Gaps, BE_All, BE_Proc, BE_Solid, BE_Turn_n, BE_f3Turns of the phase 74, 74a-74f of the at least one real signal 60-72 with the at least one respective physical indicator of the phase 74, 74a-74f of the at least one reference signal 50-54.

The present invention also relates to a method for quality control of a weld (or “weld joint”) 90 between a pair of ends 88a, 88b of conducting elements of an inductive winding of a stator, by means of at least one optical sensor device 12, 14 and an electronic control unit 20 which are mutually connected and in communication, the method comprising the steps of:
detecting and acquiring an optical emission 83 originating from the weld 90 for each welding operation between the pair of ends 88a, 88b of the conducting elements;
obtaining at least one real signal 60-72 from the optical emission 83, the real signal 60-72 being a time trend constituted by one of either a continuous time series or a plurality of consecutive discrete values of a discrete time series; and
comparing the characteristics of the real signal 60-72 of the optical emission 83 with the characteristics of a respective reference signal 50-54 of the optical emission 83, and identifying defects of the weld 90 on the basis of the relationship between the compared characteristics;
characterized in that, before the step of comparing, the method further comprises the step consisting of:
subdividing the real signal 60-72 of the optical emission 83 and the respective reference signal 50-54 of the optical emission 83 of each welding operation into a plurality of signal portions, each signal portion having respective duration corresponding to a respective time period #1-#6 (or a respective time window 76) defined by the electronic control unit 20;
and in that the step of comparing further comprises the step consisting of:
comparing each signal portion of the real signal 60-72, the duration of which is the respective time period #1-#6 (or the respective time window 76), with a respective signal portion of the reference signal 50-54, wherein a duration of the respective signal portion of the reference signal 50-54 is a corresponding time period #1-#6 (or a corresponding time window 76) of the welding operation.

In simpler words, initially, the optical sensor device 12, 14 detects an optical emission 83 originating from the weld 90, during the welding operation. Subsequently, the optical sensor device 12, 14 obtains at least one real signal 60-72 from the optical emission 83 of the weld 90.

Finally, the electronic control unit 20 compares the characteristics, for example the trend or the physical indicators, of the real signal 60-72 of the optical emission 83 of the weld 90 with the characteristics, for example the trend or the physical indicators, of a respective reference signal 50-54 of the optical emission 83 of the weld 90, so identifying any defects and/or estimating mechanical properties of the weld 90 on the basis of the variation—or, more generally, the relationship—between the compared characteristics, preferably taking into account a predefined tolerance band.

In other words, the electronic control unit 20 identifies any defects and/or estimates mechanical properties of the weld 90, by evaluating the characteristics, for example the trend or the physical indicators, of the real signal 60-72 of the optical emission 83 of the weld 90 with respect to the characteristics, for example the trend or the physical indicators, of a respective reference signal 50-54 of the optical emission 83 of the weld, preferably taking into account a predefined tolerance band.

The present invention also relates to a system 10 for quality control of a weld 90 between a pair of ends 88a, 88b of conducting elements of an inductive winding of a stator, which comprises at least one optical sensor device 12, 14 and an electronic control unit 20 which are mutually connected and in communication,
wherein the optical sensor device 12, 14 is configured for detecting and acquiring an optical emission 83 originating from the weld 90 for each welding operation between the pair of ends 88a, 88b of the conducting elements, and for obtaining at least one real signal 60-72 from the optical emission 83,
wherein the real signal 60-72 is a time trend constituted by one of either a continuous time series or a plurality of consecutive discrete values of a discrete time series, and
wherein the electronic control unit 20 is configured for comparing the characteristics of the real signal 60-72 of the optical emission 83 with the characteristics of a respective reference signal 50-54 of the optical emission 83, and for identifying defects of the weld 90 on the basis of the relationship between the compared characteristics,
characterized in that the electronic control unit 20 is further configured for subdividing the real signal 60-72 of the optical emission 83 and the respective reference signal 50-54 of the optical emission 83 of each welding operation into a plurality of signal portions, each signal portion having respective duration corresponding to a respective time period #1-#6 (or a respective time window 76) defined by the electronic control unit 20,
and in that, following this subdivision, the electronic control unit 20 is further configured for comparing each signal portion of the real signal 60-72, the duration of which is the respective time period #1-#6 (or the respective time window 76), with a respective signal portion of the reference signal 50-54, wherein a duration of the respective signal portion of the reference signal 50-54 is a corresponding time period #1-#6 (or a corresponding time window 76) of the welding operation.

In practice, it has been found that the present invention fully achieves the set aim and objects. In particular, the method and the system of welding for inductive windings of electrical machines so conceived make it possible to overcome the qualitative limitations of the known art, in that they make it possible to obtain better effects than those that can be obtained with conventional solutions and/or similar effects at lower cost and with higher performance levels.

An advantage of the method and of the system of welding for inductive windings of electrical machines according to the present invention consists in that they make it possible to examine and evaluate the welds objectively and rapidly.

Another advantage of the method and of the system of welding for inductive windings of electrical machines according to the present invention consists in that they make it possible to immediately discard a stator that has an inductive winding comprising a pair of conducting elements with an exploded weld, so saving the automatic welding process from executing all the subsequent welding operations, and as a consequence all the subsequent welds, thereby basically reducing the cycle times for discarded stators.

Another advantage of the method and of the system of welding for inductive windings of electrical machines according to the present invention consists in that they make it possible to immediately rework a poor quality weld in the welding machine, so avoiding the need to extract the stator from the welding machine and then put it back into the same machine later, after visual inspection of that stator by a human operator, thereby basically reducing the cycle times for reworking.

Another advantage of the method and of the system of welding for inductive windings of electrical machines according to the present invention consists in that they make it possible to correctly classify various types of defects, identifying one or more of the following defects: poor or insufficient weld volume, owing to lack of power and/or loss of focal position of the laser welding beam; poor or insufficient quality of deinsulation of the conducting elements; explosion of the weld; poor or insufficient internal porosity of the weld; and poor or insufficient mechanical strength (pull-out force) of the weld.

The invention, thus conceived, is susceptible of numerous modifications and variations, all of which are within the scope of the appended claims.

Except where indicated otherwise, the various embodiments described above can be combined in order to provide further and/or alternative embodiments. In addition, the present description covers combinations of variations and preferred embodiments that are not explicitly described.

Moreover, all the details may be substituted by other, technically equivalent elements.

In practice the materials employed, provided they are compatible with the specific use, and the contingent dimensions and shapes, may be any according to requirements and to the state of the art.

In conclusion, the scope of protection of the claims shall not be limited by the explanations or by the preferred embodiments illustrated in the description by way of examples, but rather the claims shall comprise all the patentable characteristics of novelty that reside in the present invention, including all the characteristics that would be considered as equivalent by the person skilled in the art.

The disclosures in Italian Patent Application No. 102023000010290 from which this application claims priority are incorporated herein by reference.

Where the technical features mentioned in any claim are followed by reference numerals and/or signs, those reference numerals and/or signs have been included for the sole purpose of increasing the intelligibility of the claims and accordingly, such reference numerals and/or signs do not have any limiting effect on the interpretation of each element identified by way of example by such reference numerals and/or signs.

1-12. (canceled)

13. A method of welding for inductive windings of electrical machines starting from U-shaped conducting elements with a bridge joining a pair of shanks, wherein said conducting elements are arranged in a ferromagnetic core of an electrical machine with said shanks oriented parallel to an axis of symmetry of said ferromagnetic core, and wherein each shank of said conducting elements comprises an end, each end being adjacent to an end of another conducting element for welding together according to a predefined electrical connection diagram;
wherein said method comprises the steps of:
arranging said ferromagnetic core containing said conducting elements in a welding zone, with said ends of said conducting elements facing a programmable focusing optic scanner controlled by an electronic control unit, said programmable focusing optic scanner being configured to project a laser welding beam;
gripping said ends to be welded together, which are mutually adjacent and aligned, an axial interspace of separation being leaved between said ends;
scanning said laser welding beam, by following a preset cyclic path and passing through at least one first end and at least one second end of said ends of said conducting elements, wherein said preset path is scanned for a plurality of cycles, for the generation of a well of molten metal in said at least first and second ends in order to close said interspace that separates them, each cycle of said scan having a preset duration;
cooling said well of molten metal, by means of shutting off said laser welding beam, up until solidification of said well of molten metal, said solidification resulting in a weld that stably connects said at least first and second ends of said adjacent conducting elements, said cooling having a preset duration;
monitoring at least one real signal of an optical emission in said steps of scanning and cooling in order to control a quality of said weld between said pair of ends of said conducting elements of an inductive winding of a stator, via at least one optical sensor device and said electronic control unit;
where said step of monitoring comprises the steps of:
detecting and acquiring said optical emission originating from said weld for said duration of said steps of scanning and cooling of each welding operation between said pair of ends of said conducting elements;
obtaining at least one real signal from said optical emission, said real signal being a time trend constituted by one of either a continuous time series or a plurality of consecutive discrete values of a discrete time series;
comparing characteristics of said at least one real signal of said optical emission with respective characteristics of at least one respective reference signal of said optical emission, and identifying defects of said weld on the basis of the relationship between said compared characteristics; and
classifying said at least one real signal on the basis of a comparison of said characteristics of said at least one real signal with said respective characteristics of said at least one respective reference signal, said classifying of said at least one real signal including identifying any defects and/or estimating mechanical properties of said weld on the basis of the single relationship between said compared characteristics;
wherein, prior to said steps of scanning and cooling, the method comprises the step of:
selecting a predefined welding program, where said welding program comprises instructions and operating parameters with which said electronic control unit is to execute said steps of scanning and cooling, where said welding program further comprises at least one reference signal of said optical emission relating to said welding program, and where said welding program further comprises at least one time window for monitoring in said steps of scanning and cooling corresponding to a phase of said welding operation;
and wherein said step of monitoring further comprises, prior to said step of comparing, the steps of:
extracting values corresponding to said phase defined by said at least one time window from said at least one real signal of said optical emission and from said at least one respective reference signal of said optical emission of each welding operation; and
calculating at least one physical indicator relating to said phase of said welding operation, starting from said values which are contained in said at least one time window and extracted from said at least one real signal and from said at least one respective reference signal;
and wherein said step of comparing further comprises the step of:
comparing said at least one physical indicator of said phase of said at least one real signal with said at least one respective physical indicator of said phase of said at least one reference signal.

14. The method of welding according to claim 13, wherein said predefined welding program comprises a reference thermal signal of said optical emission;
and wherein said step of monitoring comprises the steps of:
obtaining a real thermal signal from a radiation beam comprised in said optical emission;
extracting values relating to said phase defined by said at least one time window from said real thermal signal of said optical emission and from said respective reference thermal signal of said optical emission of each welding operation;
calculating at least one thermal signal physical indicator relating to said phase of said welding operation, starting from said values which are extracted from said real thermal signal and from said reference thermal signal;
comparing said at least one thermal signal physical indicator of said real thermal signal with said at least one respective thermal signal physical indicator of said reference thermal signal; and
classifying said real thermal signal on the basis of the comparison of said at least one thermal signal physical indicator of said real thermal signal with said at least one respective thermal signal physical indicator of said reference thermal signal, said classifying of said real thermal signal including identifying any defects and/or estimating mechanical properties of said weld on the basis of the single relationship between said compared thermal signal physical indicators.

15. The method of welding according to claim 13, wherein said predefined welding program comprises a reference plasma signal of said optical emission;
and wherein said step of monitoring comprises the steps of:
obtaining a real plasma signal from a radiation beam comprised in said optical emission;
extracting values relating to said phase defined by said at least one time window from said real plasma signal of said optical emission and from said respective reference plasma signal of said optical emission of each welding operation;
calculating at least one plasma signal physical indicator relating to said phase of said welding operation, starting from said values which are extracted from said real plasma signal and from said reference plasma signal;
comparing said at least one plasma signal physical indicator of said real plasma signal with said at least one respective plasma signal physical indicator of said reference plasma signal; and
classifying said real plasma signal on the basis of the comparison of said at least one plasma signal physical indicator of said real plasma signal with said at least one respective plasma signal physical indicator of said reference plasma signal, said classifying of said real plasma signal including identifying any defects and/or estimating mechanical properties of said weld on the basis of the single relationship between said compared plasma signal physical indicators.

16. The method of welding according to claim 13, characterized in that said predefined welding program comprises a reference back-reflection signal of said optical emission;
and wherein said step of monitoring comprises the steps of:
obtaining a real back-reflection signal from a reflection beam comprised in said optical emission;
extracting values relating to said phase defined by said at least one time window from said real back-reflection signal of said optical emission and from said respective reference back-reflection signal of said optical emission of each welding operation;
calculating at least one back-reflection signal physical indicator relating to said phase of said welding operation, starting from said values which are extracted from said real back-reflection signal and from said reference back-reflection signal;
comparing said at least one back-reflection signal physical indicator of said real back-reflection signal with said at least one respective back-reflection signal physical indicator of said reference back-reflection signal; and
classifying said real back-reflection signal on the basis of the comparison of said at least one back-reflection signal physical indicator of said real back-reflection signal with said at least one respective back-reflection signal physical indicator of said reference back-reflection signal, said classifying of said real back-reflection signal including identifying any defects and/or estimating mechanical properties of said weld on the basis of a single relationship between said compared back-reflection signal physical indicators.

17. The method of welding according to claim 13, wherein said step of monitoring comprises the steps of:
extracting values relating to a phase of solidification from said real thermal signal of said optical emission and from said respective reference thermal signal of said optical emission of each welding operation;
calculating a solidification energy physical indicator by means of a summing of all the values relating to the trend of said real thermal signal and of said respective reference thermal signal for said phase of solidification;
comparing said solidification energy physical indicator of said real thermal signal with said respective solidification energy physical indicator of said reference thermal signal; and
classifying said real thermal signal on the basis of the comparison of said solidification energy physical indicator of said real thermal signal with said respective solidification energy physical indicator of said reference thermal signal, said classifying of said real thermal signal including identifying a defect of poor internal porosity of said weld and/or estimating said internal porosity of said weld on the basis of the single relationship between said compared solidification energy physical indicators.

18. The method of welding according to claim 13, wherein said step of monitoring comprises the steps of:
extracting values relating to a phase of scanning and to a phase of solidification from said real thermal signal of said optical emission and from said respective reference thermal signal of said optical emission of each welding operation;
calculating a total energy physical indicator by means of a summing of all the values relating to the trend of said real thermal signal and of said respective reference thermal signal for said phase of scanning and said phase of solidification;
comparing said total energy physical indicator of said real thermal signal with said respective total energy physical indicator of said reference thermal signal; and
classifying said real thermal signal on the basis of the comparison of said total energy physical indicator of said real thermal signal with said respective total energy physical indicator of said reference thermal signal, said classifying of said real thermal signal including identifying a defect of poor mechanical strength of said weld and/or estimating said mechanical strength of said weld on the basis of the single relationship between said compared total energy physical indicators.

19. A system of welding for inductive windings of electrical machines starting from U-shaped conducting elements with a bridge joining a pair of shanks, wherein said conducting elements are arranged in a ferromagnetic core of an electrical machine with said shanks oriented parallel to an axis of symmetry of said ferromagnetic core, and where each shank of said conducting elements comprises an end, each end being adjacent to an end of another conducting element for welding together according to a predefined electrical connection diagram;
wherein said system is configured for:
arranging said ferromagnetic core containing said conducting elements in a welding zone, with said ends of said conducting elements facing a programmable focusing optic scanner controlled by an electronic control unit, said programmable focusing optic scanner being configured to project a laser welding beam;
gripping said ends to be welded together, which are mutually adjacent and aligned, an axial interspace of separation being leaved between said ends;
scanning said laser welding beam, by following a preset cyclic path and passing through at least one first end and at least one second end of said ends of said conducting elements, wherein said preset path is scanned for a plurality of cycles, for the generation of a well of molten metal in said at least first and second ends in order to close said interspace that separates them, each cycle of said scan having a preset duration;
cooling said well of molten metal, by means of shutting off said laser welding beam, up until solidification of said well of molten metal, said solidification resulting in a weld that stably connects said at least first and second ends of said adjacent conducting elements, said cooling having a preset duration;
monitoring at least one real signal of an optical emission in said steps of scanning and cooling in order to control the quality of said weld between said pair of ends of said conducting elements of an inductive winding of a stator, via at least one optical sensor device and said electronic control unit;
wherein said system is further configured for:
detecting and acquiring said optical emission originating from said weld for said duration of said steps of scanning and cooling of each welding operation between said pair of ends of said conducting elements;
obtaining at least one real signal from said optical emission, said real signal being a time trend constituted by one of either a continuous time series or a plurality of consecutive discrete values of a discrete time series;
comparing characteristics of said at least one real signal of said optical emission with respective characteristics of at least one respective reference signal of said optical emission, and identifying defects of said weld on the basis of the relationship between said compared characteristics; and
classifying said at least one real signal on the basis of the comparison of said characteristics of said at least one real signal with said respective characteristics of said at least one respective reference signal, said classifying of said at least one real signal including identifying any defects and/or estimating mechanical properties of said weld on the basis of the single relationship between said compared characteristics;
wherein said system is further configured for:
selecting a predefined welding program, where said welding program comprises instructions and operating parameters with which said electronic control unit is to execute said steps of scanning and cooling, where said welding program further comprises at least one reference signal of said optical emission relating to said welding program, and where said welding program further comprises at least one time window for monitoring in said steps of scanning and cooling corresponding to a phase of said welding operation;
extracting values corresponding to said phase defined by said at least one time window from said at least one real signal of said optical emission and from said at least one respective reference signal of said optical emission of each welding operation; and
calculating at least one physical indicator relating to said phase of said welding operation, starting from said values which are contained in said at least one time window and extracted from said at least one real signal and from said at least one respective reference signal; and
comparing said at least one physical indicator of said phase of said at least one real signal with said at least one respective physical indicator of said phase of said at least one reference signal.

20. The system of welding according to claim 19, wherein said predefined welding program comprises a reference thermal signal of said optical emission;
and wherein said system is further configured for:
obtaining a real thermal signal from a radiation beam comprised in said optical emission;
extracting values relating to said phase defined by said at least one time window from said real thermal signal of said optical emission and from said respective reference thermal signal of said optical emission of each welding operation;
calculating at least one thermal signal physical indicator relating to said phase of said welding operation, starting from said values which are extracted from said real thermal signal and from said reference thermal signal;
comparing said at least one thermal signal physical indicator of said real thermal signal with said at least one respective thermal signal physical indicator of said reference thermal signal; and
classifying said real thermal signal on the basis of the comparison of said at least one thermal signal physical indicator of said real thermal signal with said at least one respective thermal signal physical indicator of said reference thermal signal, said classifying of said real thermal signal including identifying any defects and/or estimating mechanical properties of said weld on the basis of the single relationship between said compared thermal signal physical indicators.

21. The system of welding according to claim 19, wherein said predefined welding program comprises a reference plasma signal of said optical emission;
and wherein said system is further configured for:
obtaining a real plasma signal from a radiation beam comprised in said optical emission;
extracting values relating to said phase defined by said at least one time window from said real plasma signal of said optical emission and from said respective reference plasma signal of said optical emission of each welding operation;
calculating at least one plasma signal physical indicator relating to said phase of said welding operation, starting from said values which are extracted from said real plasma signal and from said reference plasma signal;
comparing said at least one plasma signal physical indicator of said real plasma signal with said at least one respective plasma signal physical indicator of said reference plasma signal; and
classifying said real plasma signal on the basis of the comparison of said at least one plasma signal physical indicator of said real plasma signal with said at least one respective plasma signal physical indicator of said reference plasma signal, said classifying of said real plasma signal including identifying any defects and/or estimating mechanical properties of said weld on the basis of the single relationship between said compared plasma signal physical indicators.

22. The system of welding according to claim 19, wherein said predefined welding program comprises a reference back-reflection signal of said optical emission;
and wherein the system is further configured for:
obtaining a real back-reflection signal from a reflection beam comprised in said optical emission;
extracting values relating to said phase defined by said at least one time window from said real back-reflection signal of said optical emission and from said respective reference back-reflection signal of said optical emission of each welding operation;
calculating at least one back-reflection signal physical indicator relating to said phase of said welding operation, starting from said values which are obtained from said real back-reflection signal and from said reference back-reflection signal;
comparing said at least one back-reflection signal physical indicator of said real back-reflection signal with said at least one respective back-reflection signal physical indicator of said reference back-reflection signal; and
classifying said real back-reflection signal on the basis of the comparison of said at least one back-reflection signal physical indicator of said real back-reflection signal with said at least one respective back-reflection signal physical indicator of said reference back-reflection signal, said classifying of said real back-reflection signal including identifying any defects and/or estimating mechanical properties of said weld on the basis of the single relationship between said compared back-reflection signal physical indicators.

23. The system of welding according to claim 19, wherein the system is further configured for:
obtaining values relating to a phase of solidification from said real thermal signal of said optical emission and from said respective reference thermal signal of said optical emission of each welding operation;
calculating a solidification energy physical indicator by means of a summing of all the values relating to the trend of said real thermal signal and of said respective reference thermal signal for said phase of solidification;
comparing said solidification energy physical indicator of said real thermal signal with said respective solidification energy physical indicator of said reference thermal signal; and
classifying said real thermal signal on the basis of the comparison of said solidification energy physical indicator of said real thermal signal with said respective solidification energy physical indicator of said reference thermal signal, said classifying of said real thermal signal including identifying a defect of poor internal porosity of said weld and/or estimating said internal porosity of said weld on the basis of the single relationship between said compared solidification energy physical indicators.

24. The system of welding according to claim 19, wherein the system is further configured for:
obtaining values relating to a phase of scanning and a phase of solidification from said real thermal signal of said optical emission and from said respective reference thermal signal of said optical emission of each welding operation;
calculating a total energy physical indicator by means of a summing of all the values relating to the trend of said real thermal signal and of said respective reference thermal signal for said phase of scanning and said phase of solidification;
comparing said total energy physical indicator of said real thermal signal with said respective total energy physical indicator of said reference thermal signal; and
classifying said real thermal signal on the basis of the comparison of said total energy physical indicator of said real thermal signal with said respective total energy physical indicator of said reference thermal signal, said classifying of said real thermal signal including identifying a defect of poor mechanical strength of said weld and/or estimating said mechanical strength of said weld on the basis of the single relationship between said compared total energy physical indicators.
